(19) United States
(12) Patent Application Publication
(10) Pub. No.: US 2026/0162097 A1
(43) Pub. Date: Jun. 11, 2026

(54) REAL-TIME PROVISIONING OF WALLET-COMPATIBLE PRODUCTS DURING PROGRAMMATIC CHAT SESSIONS

(71) Applicant: THE TORONTO-DOMINION BANK, Toronto (CA)

(72) Inventor: Dino Paul D'AGOSTINO, Richmond Hill (CA)

(21) Appl. No.: 19/179,332

(22) Filed: Apr. 15, 2025

Related U.S. Application Data
(60) Provisional application No. 63/634,225, filed on Apr. 15, 2024.

(51) Int. Cl. G06Q 20/36; G06Q 20/38

(52) U.S. Cl. CPC G06Q 20/36; G06Q 20/3825

(57) ABSTRACT

The disclosed embodiments include computer-implemented systems and processes that facilitate a real-time provisioning of wallet-compatible products to digital wallets during programmatic chat sessions. A device may receive, during an established chat session between the device and at least a computing system, message data that includes a data package associated with an approved product and a corresponding digital signature. The chat session may involve an autonomous agent. The device may present digital content characterizing the approved product within a digital interface associated with the established chat session, and may obtain elements of input data associated with the presented digital content. Based on the elements of input data, perform operations that store at least a portion of the data package within a secure portion of a memory, and the storage of the portion of the data package may provisioning the approved product into a digital wallet associated with an executed application program.

### CROSS-REFERENCE TO RELATED APPLICATION

This application claims the benefit of priority to U.S. Provisional Application No. 63/634,225, filed on Apr. 15, 2024, the entire disclosure of which is expressly incorporated herein by reference to its entirety.

### TECHNICAL FIELD

The disclosed embodiments generally relate to computer-implemented systems and processes that facilitate a real-time provisioning of wallet-compatible products to digital wallets during programmatic chat sessions.

### BACKGROUND

The mass adoption of smart phones, tablet computers, and other wearable technologies within the global marketplace facilitates an adoption, by many organizations, of various digital channels as mechanisms for communicating with, and interacting with, their customers. The mass adoption of these technologies also drives a wide adoption of digital wallets and related technologies by consumers and retailers throughout the global marketplace.

### SUMMARY

In some examples, a device includes a memory storing instructions, a communications interface, and at least one processor coupled to the memory and the communications interface. The at least one processor is configured to execute the instructions to receive message data via the communications interface. The message data is received during a chat session established with between the device and at least a computing system, and the message data includes a data package associated with an approved product and a corresponding digital signature. The at least one processor is further configured to execute the instructions present digital content characterizing the approved product within a digital interface associated with the established chat session, and obtain elements of input data associated with the presented digital content. The at least one processor is further configured to execute the instructions to, based on the elements of input data, perform operations that store at least a portion of the data package within a secure portion of the memory. The secure portion of the memory is associated with a first application program executed by the at least one processor, and the stored portion of the data package provisions the approved product into a digital wallet associated with the executed first application program.

In other examples, a computer-implemented method includes receiving message data using at least one processor. The message data is received during a chat session established between a device and a computing system, and the message data includes a data package associated with an approved product and a corresponding digital signature. The computer-implemented method also includes presenting, using the at least one processor, digital content characterizing the approved product within a digital interface associated with the established chat session, and obtaining, using the at least one processor, elements of input data associated with the presented digital content. The computer-implemented method also includes, based on the elements of input data, performing operations, using the at least one processor, that store at least a portion of the data package within a secure portion of a memory. The secure portion of the memory is associated with an application program executed by the at least one processor, and the stored portion of the data package provisions the approved product into a digital wallet associated with the executed application program.

Additionally, in some examples, a device includes a memory storing instructions, a communications interface, and at least one processor coupled to the memory and the communications interface. The at least one processor is configured to execute the instructions to receive first message data via the communications interface. The first message data being received during a chat session established between the device and a computing system. The at least one processor is further configured to execute the instructions to transmit, via the communications interface, elements of application data that include at least a portion of the first message data to an additional computing system. The additional computing system performs operations that approve a product based on the elements of application data. The at least one processor is further configured to execute the instructions to receive, via the communications interface, a data package associated with the approved product and a corresponding digital signature from the additional computing system, and to transmit, via the communications interface, second message data to the computing system during the established chat session. The second message data includes the data package and the digital signature, and the computing system is configured to transmit the second message data to an additional device during the established chat session.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1 and 2A-2D are block diagrams illustrating portions of an exemplary computing environment, in accordance with some exemplary embodiments.

FIGS. 3-5 are flowcharts of exemplary processes for provisioning a wallet-compatible product into a digital wallet during a secure, programmatic chat session, in accordance with some exemplary embodiments.

Like reference numbers and designations in the various drawings indicate like elements.

### DETAILED DESCRIPTION

The mass adoption of smart phones, tablet computers, and other wearable technologies within the global marketplace facilitates an adoption, by many organizations, of digital channels as mechanisms for communicating with, and interacting with, their customers, and an adoption of digital wallets and related technologies by the organizations and their customers. For example, many organizations, such as governmental agencies, transit agencies, retailers, and financial institution, offer wallet-compatible products to their customers, and upon a provisioning of these wallet-compatible products into digital wallets maintained by corresponding computing devices or computing systems, the provisioned, wallet-compatible products and instruments may be available for use in contactless or digital transactions involving the customer computing devices or computing systems.

Despite the wide adoption of these wallet-compatible products and corresponding digital wallets by both the organizations and their customers, many existing processes that enable a customer to provision a wallet-compatible product into a digital wallet maintained at the customer's device (e.g., as established and maintained by an executed wallet application, such as Apple Pay™ or Google Wallet™) require that customer possess a physical instrument or card associated with the wallet-compatible product. For example, upon receipt of the physical instrument or card, which may occur several days or weeks after an issuance of the wallet-compatible product by a corresponding organization, the customer may request, via a mobile application or web browser executed at the customer's device, an addition of the wallet-compatible product associated with the physical instrument or card to the customer's digital wallet. Based on a validation of additional authentication credentials of the customer and a determination that the customer is in possession of the physical instrument or card (e.g., the entry of a portion of a customer identifier, such as a social security number, and a corresponding card verification code of the physical payment card), the executed mobile application may transmit a request to add the physical instrument or card to the customer's digital wallet across a communications network to an approval system associated with the physical instrument or card, e.g., that approved the issuance of the wallet-compatible product to the customer.

Upon receipt of the request, and upon approval of that request, the approval system may perform operations that package one or more secure account credentials associated with the wallet-compatible product into a secure data package, and that apply an appropriate digital signature to the secure data package. By way of example, the secure account credentials may include, among other things, a digital token representative of an account number of the wallet-compatible product, and the approval system may transmit the digitally signed, secure data package across the communications network to a back-end computing system associated with the wallet application executed at the customer's device. The back-end computing system may perform operations that validate the digital signature applied to the secure data package, and based on the validation of that digital signature, the back-end computing system may establish a secure, programmatic channel of communications with the executed mobile wallet application (e.g., at the customer's device) and provision the secure data package, which includes the secure account credentials, to the executed wallet application via the established channel of communications. The executed wallet application may receive the secure data package, extract the secure account credentials, and store the secure account credentials within a corresponding portion of a device memory (e.g., within a secure element, etc.), which may add the wallet-compatible product to the customer's digital wallet. The provisioned wallet-compatible product may then be available for use in contactless and digital transactions involving the customer's device.

Recent changes to the issuance protocols and processes may, however, enable the approval system to approve applications for new wallet-compatible product in real-time or in near-real time (e.g., within a predetermined temporal interval of a receipt of the corresponding application, such as a five-minute temporal interval). Despite being approved and issued in real-time, many of the existing processes for adding wallet-compatible products into a customer's digital wallet rely on the possession of a physical instrument or card by the customer, which may delay, often significantly, the customers'ability to access and utilize these resources until after the receipt of the physical card or instrument.

Building on the increased reliance on chat-based interfaces as a mechanism for communicating and interacting with customers, one or more computing systems of an organization may perform operations that, based on data exchanged between a customer and an agent of the organization across a secure, programmatic chat session, facilitate an application for a wallet-compatible product (e.g., a payment instrument, a gift card associated with a corresponding retailer, a transit pass, etc.) by the agent on behalf of the customer, an issuance of an account number associated with the wallet-compatible product to the customer, and a provisioning of a cryptographically secure, digitally signed data package that includes the secure account credentials of the wallet-compatible product to a wallet application executed by the customer's device via a digital interface associated with the secure, programmatic chat session. In some instances, the cryptographically secure digitally signed data packet may be provisioned to the customer's device via the digital interface during the secure, programmatic chat session in real-time (or in near-real-time) and contemporaneously with the issuance of the wallet-compatible product to the customer, e.g., within a five-minute temporal interval.

The executed wallet application may, in some instances, process the cryptographically secure, digitally signed data package and provision securely the wallet-compatible product to the customer's digital wallet without the additional manual authentication processes that rely on a corresponding, physical card, or the additional communications between the one or more computing systems of the organization and the back-end computing system associated with the executed wallet application, which characterize the existing processes for adding wallet-compatible to the customer's digital wallet. Upon provisioning into the customer's mobile wallet through an implementation of one or more of the exemplary processes described herein, the wallet-compatible product may be available for use in contactless or digital transactions involving the device and the executed wallet application in real-time and contemporaneously with the issuance of the instrument by the one or more computing systems of the financial institution, and the maintenance of the secure, programmatic chat session may enable the agent to address, in real-time, any problems encountered during the provisioning of the wallet compatible instrument into the customer's digital wallet.

Certain of the exemplary processes described herein, which provision a digitally signed data packet that includes secure account credentials of a wallet-compatible product to a wallet application executed by a customer's device via a digital interface of a secure, programmatic chat session in real-time (or in near-real-time) and contemporaneously with an issuance of the account number to the customer, may be implemented in addition to, or as an alternate to, many existing processes for adding wallet-compatible products to a customer's digital wallet, which are often characterized by additional manual authentication processes that rely on a corresponding, physical card, and on additional communications between one or more computing systems associated with the wallet-compatible products and a back-end computing system associated with the executed wallet application.

A. Exemplary Computing Environments that Facilitate Programmatic Chat Sessions between Network-Connected Devices

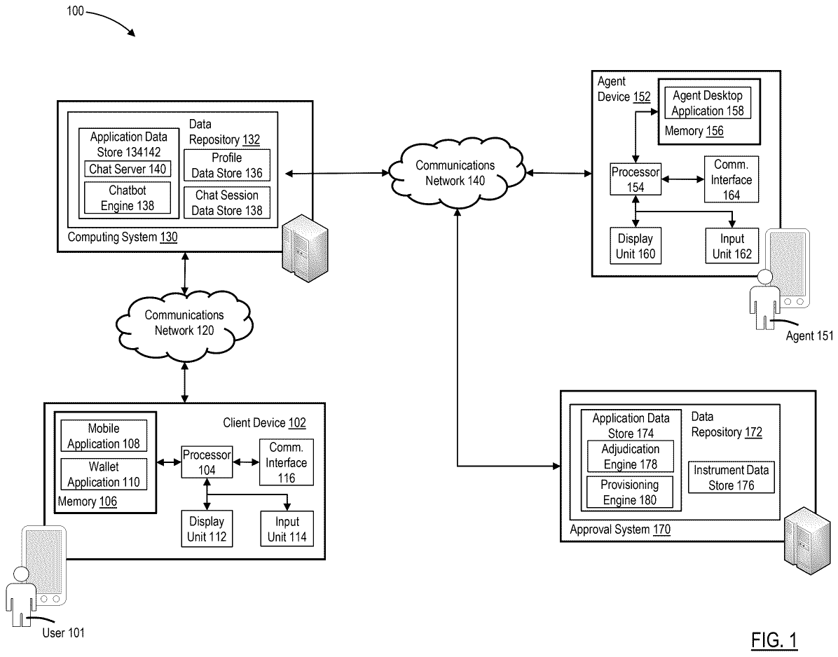

FIG. 1 illustrates components of a computing environment 100, in accordance with some exemplary embodiments. For example, as illustrated in FIG. 1, environment 100 may include one or more computing systems associated with organization, such as a computing system 130 and an approval system 170, and one or computing devices, such as client device 102 and agent device 152. In some instances, each of the one or more computing systems, including computing system 130 and approval system 170, and each of the one or more computing devices, including client device 102 and agent device 152 may be interconnected by, and may communicate across, a corresponding, common communications network, such as, but not limited to, a wide area network (WAN), e.g., the Internet. Additionally, or alternatively, as illustrated in FIG. 1, computing system 130 and client device 102 may be interconnected by, and communicate across, a first communications network, such as communications network 120, and computing system 130, agent device 152, and approval system 170 may be interconnected by, and may communicate across, a second communications network, such as communications network 140.

For example, communications network 120 may correspond to a public communications network accessible to the one or more computing systems or devices operating within environment 100, and communications network 140 may correspond to a private communications network accessible to a subset of the computing systems and devices that operate within environment 100 and that are associated with the organization (e.g., computing system 130 and approval system 170) or operable by representatives or agents of that organization (e.g., agent device 152). As described herein, communications network 140 may be inaccessible to client device 102 via communications network 120 (e.g., via a corresponding firewall and established access protocols, etc.), and in some instances, computing system 130 may represent a secure endpoint of communications network 140. Examples of communications network 120 and communications network 140 include, but are not limited to, a wireless local area network (LAN), e.g., a Wi-Fi™ network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

As illustrated in FIG. 1, client device 102 and agent device 152 may each include a computing device having one or more processors (e.g., processor 104 of client device 102 and processor 154 of agent device 152) and one or more tangible, non-transitory memories coupled to corresponding ones of the processors (e.g., memory 106 of client device 102 and memory 156 of agent device 152) and storing data and/or software instructions. Examples of these software instructions may include, but are not limited to, one or more application programs, application modules, and other elements of executable code, which may be executed by corresponding ones of processor 104 and processor 154.

For example, client device 102 may maintain, within memory 106, an executable mobile application 108 and an executable wallet application 110. In some instances, mobile application 108 may be associated with the organization, such as, but not limited to, the financial institution, retailer, governmental organization, transit organization, or other third-party organization described herein, and in some instances, mobile application 108 may be provisioned to client device 102 by computing system 130. Further, upon execution by processor 104, executed mobile application 108 may perform any of the exemplary processes described herein to establish a secure channel of communications with a chat server executed by the one or more processors of computing system 130 across network 120. Executed mobile application 108 may also perform any of the exemplary processes described herein to initiate and maintain, via the secure communications channel established with the executed chat server, establish and maintain a programmatic communications session with a representative of the organization via one or more corresponding devices (e.g., a secure, programmatic chat session established and maintained with agent device 152 operated by agent 151) and additionally, or alternatively, with an additional application program executed by computing system 130 (e.g., a secure chatbot session established and maintained with a chatbot associated with the organization).

Further, upon execution by the processor 104 of client device 102, executed wallet application 110 may perform any of the exemplary processes described herein to establish and maintain a digital wallet associated with a corresponding user, such as user 101. For example, executed wallet application 110 may establish and maintain the digital wallet within a secure partition of memory 106 (e.g., a secure element, etc.), and the digital wallet may include account credentials associated with one or more wallet-compatible products, such as, but not limited to, the payment instruments, loyalty or rewards accounts, government-issued identifiers (such as driver's licenses, etc.), medical credentials (e.g., vaccination records), transit passes (e.g., Presto™ cards, etc.), and stored-value card associated with corresponding retailers (e.g., Starbucks™ gift cards, etc.), as described herein. The disclosed embodiments, however, are not limited to these exemplary application programs, and in other examples, memory 106 may include any additional or alternate application programs, application modules, or other elements of code executable by client device 102, such as, but not limited to, one or more executable web browsers (e.g., Google Chrome™), for example.

Further, although not illustrated in FIG. 1, client device 102 may also establish and maintain, within memory 106, one or more structured or unstructured data repositories or databases, which may include information that uniquely identifies client device 102 and that facilitates, or supports, an execution of any of the application programs described herein. For example, the information that uniquely identifies client device 102 may include, but is not limited to, a media access control (MAC) address of client device 102 or an Internet Protocol (IP) address assigned to client device 102, and the information that facilitates, or supports, an execution of the application programs may include information that enables executable mobile application 108 to authenticate an identity of a user operating client device 102, such as user 101. Examples of this supporting information include, but are not limited to, one or more alphanumeric login or authentication credentials assigned to user 101, for example, by computing system 130, or one or more biometric credentials of user 101, such as fingerprint data or a digital image of a portion of user 101's face, or other information facilitating a biometric or multi-factor authentication of user 101. Further, in some instances, the information maintained within the structured or unstructured data repositories or databases include additional information that uniquely identifies one or more of the exemplary application programs described herein, such as a cryptogram associated with mobile application 108.

By way of example, agent device 152 may maintain, within memory 156, an executable agent desktop application 158 associated with computing system 130 and with the organization (e.g., a Finesse Agent™ desktop). Upon execution by processor 154 of agent device 152, executed agent desktop application 158 may perform any of the exemplary processes described herein to establish a secure channel of communications with the chat server executed by the one or more processors of computing system 130 across network 140. Executed agent desktop application 158 may also perform any of the exemplary processes described herein to initiate and maintain, via the secure communications channel established with the executed chat server, a programmatic communications session with a customer of the organization (e.g., a secure, programmatic chat session established and maintained with client device 102 operated by user 101) and additionally, or alternatively, with an additional application program executed by computing system 130 (e.g., a secure chatbot session established and maintained with a chatbot associated with the organization).

Further, although not illustrated in FIG. 1, agent device 152 may also establish and maintain, within memory 156, one or more structured or unstructured data repositories or databases, which may include information that uniquely identifies agent device 152 and that facilitates, or supports, an execution of any of the application programs described herein. For example, the information that uniquely identifies agent device 152 may include, but is not limited to, a MAC address of agent device 152 or an IP address assigned to agent device 152, and the information that facilitates, or supports, an execution of the application programs may include information that enables executed agent desktop application 158 to authenticate an identity of an agent operating agent device 152, such as agent 151. Examples of this supporting information include, but are not limited to, one or more alphanumeric login or authentication credentials assigned to agent 151, or one or more biometric credentials of agent 151, or other information facilitating a biometric or multi-factor authentication of agent 151. Further, in some instances, the supporting information may also include a unique identifier of executed agent desktop application 158, such as, but not limited to, an application cryptogram.

In some instances, client device 102 may include a display unit 112 configured to present elements to user 101 and an input unit 114 configured to receive input from user 101, and agent device 152 may include a display unit 160 configured to present elements to agent 151 and an input unit 162 configured to receive input from agent 151. By way of example, display units 112 and 160 may each include, an LCD display unit, a LED display unit, or other appropriate type of display unit, and input units 114 and 162 may each include a keypad, keyboard, touchscreen, fingerprint scanner, voice activated control technologies, stylus, or any other appropriate type of input unit. Further, in some examples, the functionalities of display unit 112 and input unit 114, and additionally, or alternatively, of display unit 160 and input unit 162, may be combined into a single device, such as a pressure-sensitive touchscreen display unit that can present elements (e.g., graphical user interface) and can detect an input via a physical touch. Client device 102 and agent 151 may also include a respective one of communications interfaces 118 and 164, such as a wireless transceiver device, which may be coupled to a corresponding one of processors 104 and 154. Communications interfaces 118 and 164 may establish and maintain communications with communications networks 120 and 140, respectively, via a corresponding communications protocol, such as WiFi®, Bluetooth®, NFC, a cellular communications protocol (e.g., LTE®, CDMA®, GSM®, etc.), or any other suitable communications protocol.

Examples of client device 102 and agent device 152 may include, but are not limited to, a personal computer, a laptop computer, a tablet computer, a notebook computer, a hand-held computer, a personal digital assistant, a portable navigation device, a mobile phone, a smartphone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface module, consistent with disclosed embodiments. In some instances, user 101 may operate client device 102 and may do so to cause client device 102 to perform one or more operations consistent with the disclosed embodiments, and agent 151 may operate agent device 152 and may do so to cause agent device 152 to perform one or more operations consistent with the disclosed embodiments In some instances, each of computing system 130 and approval system 170 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Each of computing system 130 and approval system 170 may also include a communications interface, such as one or more wireless transceivers, coupled to the one or more processors for accommodating wired or wireless internet communication with other computing systems and devices operating within environment 100.

Further, in some instances, computing system 130 and approval system 170 may each be incorporated into a respective, discrete computing system. In additional, or alternate, instances, one or more of computing system 130 and approval system 170 may correspond to a distributed computing system having a plurality of interconnected, computing components distributed across an appropriate computing network, such as communications network 120 or communications network 140 of FIG. 1. For example, computing system 130 may correspond to a distributed or cloud-based computing cluster associated with and maintained by the financial institution, although in other examples, computing system 130 may correspond to a publicly accessible, distributed or cloud-based computing cluster, such as a computing cluster maintained by Microsoft Azure™, Amazon Web Services™, Google Cloud™, or another third-party provider.

In some instances, computing system 130 may include a plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

In some instances, computing system 130 may perform any of the exemplary processes described herein, to execute a chat server capable of establishing a secure, programmatic chat session across a corresponding communications network between mobile application 108 executed by processor 104 of client device 102 and agent desktop application 158 executed by processor 154 of agent device 152, and additionally, or alternatively, between executed mobile application 108 and chatbot programmatically established by one or more application programs executed by computing system 130. Further, and through a performance of one or more of the exemplary processes described herein, computing system 130 (and approval system 170) may provision a digitally signed data packet that includes secure account credentials of a wallet-compatible product to executed wallet application 110 of client device 102 via the secure, programmatic chat session in real-time (or in near-real-time) and contemporaneously with an issuance of the of the wallet-compatible product to user 101. Certain of these exemplary processes may be implemented in addition to, or as an alternate to, many existing, computer-implemented processes for adding wallet-compatible products to a digital wallet, which are often characterized by additional manual authentication processes that rely on a corresponding, physical instrument (e.g., a card, etc.), and on additional, and potentially insecure, communications between approval system 170 and a back-end computing system associated with executed wallet application 110.

Referring back to FIG. 1, and to facilitate a performance of one or more of these exemplary processes, computing system 130 may maintain, within the one or more tangible, non-transitory memories, a data repository 132 that includes an application data store 134, a profile data store 136, and a chat session data store 138. In some instances, application data store 134 may include one or more application programs executable by the one or more processors of computing system 130, such as, but not limited to, executable chat server 142 and executable chatbot engine 144. For example, upon execution by the one or more processors of computing system 130, executed chat server 142 may perform any of the exemplary processes described herein to establish a first, secure channel of communication across network 120 with mobile application 108 executed by client device 102, and to established a second, secure channel of communications across network 140 with agent desktop application 158 executed by agent device 152. Further, upon the establishment of the first and second secure channels of communications, executed chat server 142 may also perform any of the exemplary processes described herein to establish, and maintain, a secure, programmatic chat session between executed mobile application 108 of client device 102 and executed agent desktop application 158 of agent device 152. As described herein, network 140 may be inaccessible to client device 102 via communications network 120 (e.g., via a corresponding firewall and established access protocols, etc.), and in some instances, the secure, programmatic chat session established and maintained by executed chat server 142 may facilitate direct chat-based communication between client device 102 and agent device 152 despite the inaccessibility of network 140 to client device 102.

Further, and upon execution of the one or more processors of computing system 130, executed chatbot engine 144 may perform any of the exemplary processes described herein to process message data received from client device 102 during the secure, programmatic chat session (e.g., based on input provided to a digital interface generated and presented by executed mobile application 108), to adaptively and dynamically parse the message data to establish a meaning and/or a context of the message data and further, to generate and provision, to the digital interface generated by executed mobile application 108, a response to the message data via the first, secure communications channel during the secure, programmatic chat session. In some instances, when presented to user 101 on the digital interface (e.g., via display unit 112 of client device 102), the presented response may simulate an ongoing and contextually relevant dialog between user 101 and an artificially and programmatically generated chatbot associated with the organization, and based on the dialog between the programmatically generated chatbot and user 101, executed chatbot engine 144 may perform one or more of the exemplary processes described herein, either alone or in conjunction with executed chat server 142, to provision the digitally signed data packet that includes the secure account credentials of the wallet-compatible product to executed wallet application 110 during the secure, programmatic chat session, e.g., in real-time (or in near-real-time) and contemporaneously with an issuance of the of the wallet-compatible product to user 101.

Referring back to FIG. 1, profile data store 136 may include discrete data records that maintain, among other things, elements of profile data that identify and characterize one or more customers of the organization. By way of example, and for a particular customer, the elements of profile data may include a corresponding, unique customer identifier (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing a relationship between the particular customer and the organization. In some instances, the elements of profile data maintained within the discrete data records of profile data store 136 may facilitate a programmatic submission of an application for a wallet-compatible product to approval system 170 by executed agent desktop application 158, and additionally, or alternatively, by executed chatbot engine 144, using any of the exemplary processes described herein.

Further, chat session data store 138 may include structured or unstructured data records that identify and characterize one or more of the chat sessions initiated, and maintained, by executed chat server 142 during one or more temporal intervals, such, but not limited to, the chat sessions initiated between executed mobile application 108 at client device 102 and executed agent desktop application 158 at agent device 152, and additionally, or alternatively, the chat sessions (e.g., “chatbot” sessions) initiated between executed mobile application 108 at client device 102 and executed chatbot engine 144 at computing system 130. By way of example, and for a particular one of the chat sessions, the data records of chat session data store 138 may include, but are not limited to, information that identifies a party that initiated or participates in that previously established chatbot session (e.g., a login credential associated with user 101, a device identifier of client device 102, a unique identifier of an executed application program, such as an application cryptogram, etc.), a time or date associated with the chat session, or a duration of that initiated chat session. In other instances, and for the particular one of the chat sessions, the data records of chat session data store 138 may also include raw or processed information that identifies and characterizes the data exchanged programmatically between client device 102 (e.g., by executed mobile application 108) and a corresponding one of agent device 152 (e.g., by executed agent desktop application 158) or computing system 130 (e.g., by executed chatbot engine 144).

Further, and to facilitate a performance of one or more of these exemplary processes, approval system 170 system 130 may maintain, within the one or more tangible, non-transitory memories, a data repository 172 that includes an application data store 174 and an instrument data store 176. As illustrated in FIG. 1, application data store 174 may include one or more application programs executable by the one or more processors of computing system 170, such as, but not limited to, executable adjudication engine 178 and executable provisioning engine, and instrument data store 176 may include structured or unstructured data records that identify and characterize one or more wallet-compatible products available for provisioning by approval system 170, and further, that include data supporting an adjudication of an application for each of the wallet-compatible products (e.g., as generated by executed agent desktop application 158 and/or executed chatbot engine 144) and a generation of a digitally signed data packet that includes secure account credentials of each of the wallet-compatible products.

### B. Exemplary Processes for a Real-Time Provisioning of Wallet-compatible Products to Digital Wallets During Programmatic Chat Sessions

In some instances, the one or more processors of client device 102, such as processor 104, may execute mobile application 108, and user 101 may provision one or more authentication credentials to executed mobile application 108, e.g., to client device 102 via input unit 114. The provisioned authentication credentials may include, among other things, an alphanumeric login name of user 101, an alphanumeric password, or a biometric credential (e.g., a fingerprint scan, a facial image, etc.), and based on a successful authentication of the identify of user 101, and based on further input provisioned to the customer device (e.g., responsive to digital content provisioned to one or more display screens of a digital interface of executed mobile application 108, e.g., via display unit 112), executed mobile application 108 may perform operations that generate, and cause client device 102 to transmit across network 120, a request to establish a chat session with agent desktop application 158 executed by agent device 152 and additionally, or alternatively, with a programmatic chatbot established by chatbot engine 144 upon execution by the one or more processors of computing system 130.

The request may, for example, include one or more of the authentication credentials of user 101, an identifier of executed mobile application 108 (e.g., an application cryptogram or token of specified format, etc.), an identifier of client device 102 (e.g., an IP or MAC address, etc.), and in some instances, elements of data that confirm the successful authentication of the customer's identity, such as, but not limited to, a digital signature applied to the request by the executed mobile application 108 (e.g., based on an encryption of a hash value representative of the request using a private cryptographic key associated with executed mobile application 108. Further, in some instances, and prior to the application of the digital signature, the request may be encrypted to mask confidential elements of the authentication credentials, e.g., using a public cryptographic key associated with computing system 130.

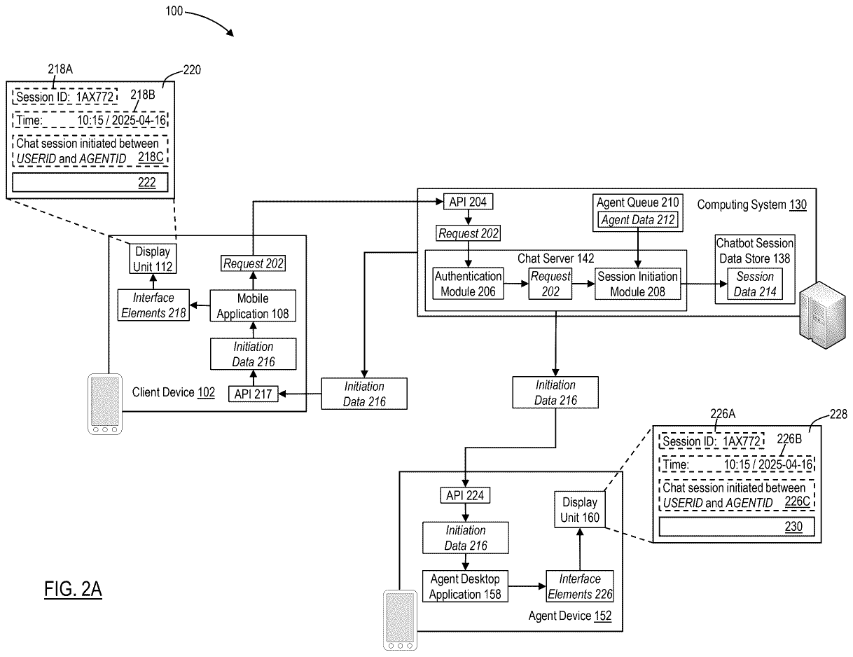

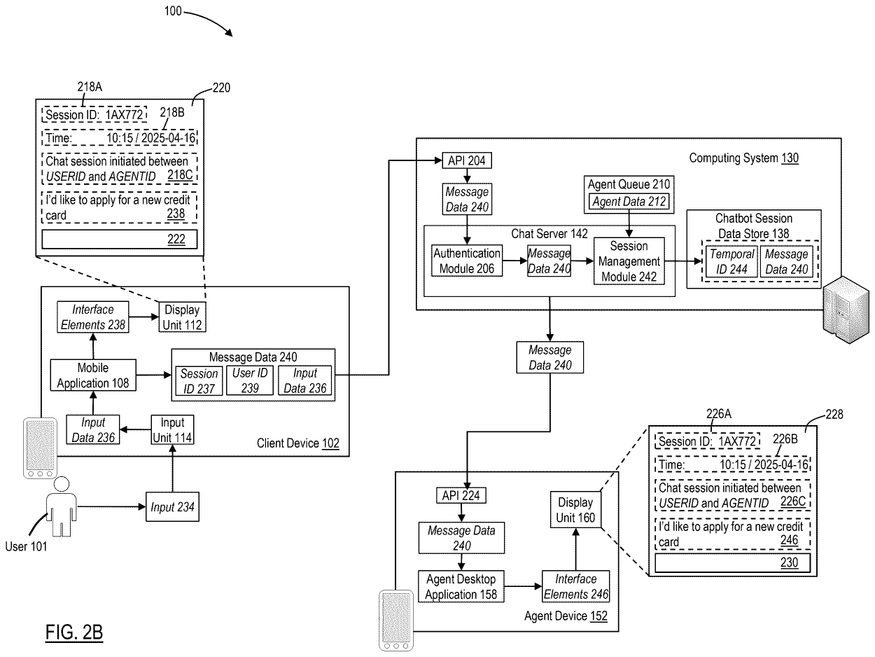

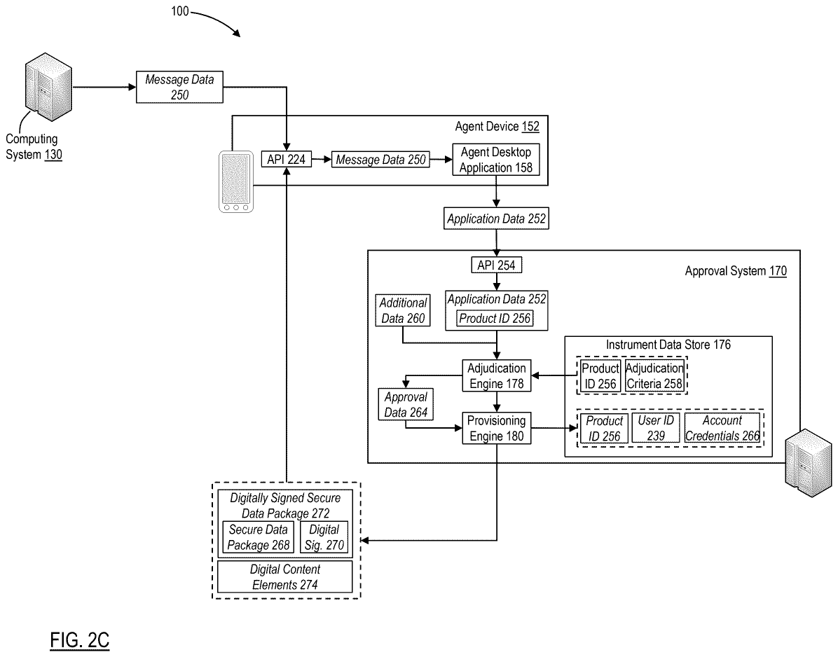

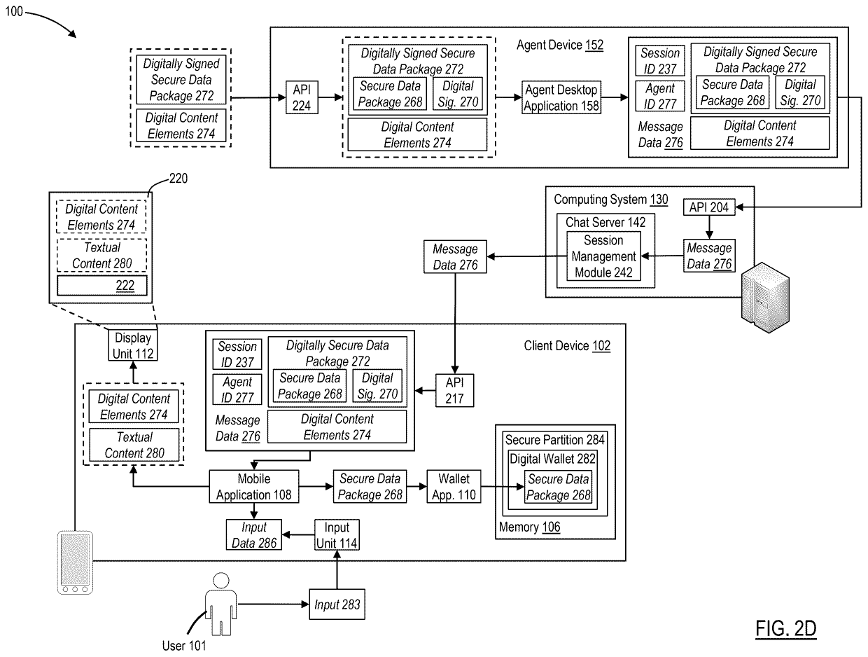

Referring to FIG. 2A, executed mobile application 108 may perform any of the exemplary processes described herein to generate the request, e.g., request 202, to apply a digital signature to request 202 based on a private cryptographic key associated with executed mobile application 108. In some instances, executed mobile application 108 may cause client device 102 to transmit request 202 and the applied digital signature across network 120 to computing system 130. A programmatic interface established and maintained by computing system 130, such as application programming interface (API) 204 associated with chat server 142, may receive request 202 and the applied digital signature, and API 204 may provide request 202 as an input to chat server 142, which may be executed by the one or more processors of computing system 130. As illustrated in FIG. 2A, an authentication module 206 of executed chat server 142 may receive request 202 (and in some instances, the applied digital signature), and executed authentication module 206 may perform operations that verify an authenticity or an integrity of request 202, e.g., based on a validation of the applied digital signature.

For example, executed authentication module 206 may perform operations that validate the digital signature applied to request 202 using a public cryptographic key of executed mobile application 108, and as described herein, the validation of the applied digital signature may confirm the integrity of request 202 (e.g., that the data maintained within request 202 remains unmodified during transmission across network 120) and may confirm the prior authentication of the identity of user 101 by executed mobile application 108. If, for example, executed authentication module 206 were unable to verify the integrity or the authenticity of request 202 (e.g., executed authentication module 206 fails to validate the applied digital signature, etc.), executed chat server 142 may decline to initiate the requested chat session with executed mobile application 108. Executed authentication module 206 may generate elements of notification data that confirm a declined status of the request, and computing system 130 may transmit the elements of notification data across network 120 to client device 102 (not illustrated in FIG. 2A).

Alternatively, if executed authentication module 206 were to verify the integrity or the authenticity of request 202 (e.g., based on a successful validation of the applied digital signature), executed chat server 142 may elect to initiate the requested chat session, and executed authentication module 206 may provide request 202 as an input to a session initiation module 208 of executed chat server 142. As described herein, all or a selected portion of the data maintained within request 202 may be encrypted, and in some instances, executed authentication module 206 may decrypt the encrypted portions of request 202 and provide the decrypted portions of request 202 as inputs to executed session initiation module 208. Executed session initiation module 208 may receive request 202 and as illustrated in FIG. 2A, executed session initiation module may store the elements of request 202 (e.g., the alphanumeric login credential of user 101, the alphanumeric password of user 101, the biometric credential of user 101, etc.) within a data repository accessible to computing system 130, such as, but not limited to, within chat session data store 138 of data repository 132.

Further, executed session initiation module 208 may generate a unique session identifier for a secure, programmatic chat session associated with now-validated request 202 (e.g., an alphanumeric character string, etc.) and may perform operations that allocate the secure, programmatic chat session to an available agent of the organization, such as, but not limited to, agent 151 associated with agent device 152. For example, executed session initiation module 208 may access elements of an agent queue 210 that identify one or more agents of the organization that are available for allocation to the secure, programmatic chat session, and executed session initiation module 208 may obtain, from agent queue 210, elements of agent data 212 that identify and characterize agent 151 associated with agent device 152. The elements of agent data 212 may, in some instances, include a unique agent identifier of agent 151 (e.g., an alphanumeric identifier, etc.), a unique identifier of executed agent desktop application 158 (e.g., a corresponding application cryptogram or token), and a unique identifier of the agent device 152 (e.g., a corresponding IP or MAC address, etc.).

The disclosed embodiments are, however, not limited to processes that allocate the secure, programmatic chat session to an available agent of the organization, and in additional or alternative examples (not illustrated in FIG. 2A), executed session initiation module 208 may also perform operations that allocate the chat session to a programmatic chatbot associated with the organization, such as, but not limited to, a chatbot established by chatbot engine 144. Based on the allocation of the secure, programmatic chat session to the chatbot, executed session initiation module 208 may perform additional operations that trigger an execution of chatbot engine by the one or more processors of computing system 130. In some instances, also not illustrated in FIG. 2A, executed chatbot engine 144 may establish the chatbot associated with the organization, which may simulate an ongoing and contextually relevant dialog with user 101 during the secure, programmatic chat session (e.g., within a secure chatbot session).

Referring back to FIG. 2A, executed session initiation module 208 may generate elements of session data 214 that identify and characterize the secure, programmatic chat session, the allocated agent and agent device, and the requesting user and client device, and executed session initiation module 208 may store the generated elements of session data 214 within a data repository accessible to computing system 130, such as, but not limited to, within chat session data store 138 of data repository 132. By way of example, the elements of session data 214 may include the unique session identifier of the chat session, temporal data that identifies a date or time associated with the initiation of the secure, programmatic chat session and all, or a selected portion of, the elements of agent data 212 that identifies agent 151 and agent device 152 (e.g., the unique agent identifier of agent 151, the unique application identifier of executed agent desktop application 158, and/or the unique device identifier of agent device 152, etc.). Further, the elements of session data 214 may include also include all, or a selected portion, of request 202 that identifies user 101 and client device 102, such as, but not limited to, the authentication credentials of user 101, the application identifier of the executed mobile application 108, and/or the device identifier of client device 102.

Executed session initiation module 208 may also generate elements of initiation data 216 associated with the initiated chat session and perform operations that cause computing system 130 to transmit the generated elements of initiation data 216 across network 120 to client device 102 (e.g., based on the device identifier of client device 102) and further, across network 140 to agent device 152 (e.g., based on the device identifier of agent device 152). The elements of initiation data 216 may include the unique session identifier of the chat session, the temporal data associated with the initiation of the chat session, the unique identifiers of user 101 and agent 151, and in some instances, elements of textual content indicating the initiation of the chat session.

In some instances, a programmatic interface established and maintained by client device 102, such as API 217 associated with executed mobile application 108, may receive the elements of initiation data 216 across network 120 from computing system 130, and may route the elements of initiation data 216 to executed mobile application 108. Executed mobile application 108 may, for example, store the elements of initiation data 216 within a corresponding portion of a data repository accessible to executed mobile application 108, such as within a portion of memory 106, and executed mobile application 108 may perform operations that generate one or more interface elements 218 of a corresponding digital interface associated with the initiated chat session, and that populate each of interface elements 218 with a corresponding portion of the elements of initiation data 216. For example, corresponding ones of the interface elements 218A and 218B may be populated, respectively, with the unique session identifier of the initiated chat session and the temporal data associated with the initiation of chat session. Further, in some instances, one or more of interface elements 218, such as interface elements 218C, may be populated with the identifiers of user 101 and agent 151 and with all, or a selected subset of, elements of textual content indicating the initiation of the chat session.

Executed mobile application 108 may provide interface elements 218 (including interface elements 218A, 218B, and 218C) to display unit 112, which may render interface elements 218 for presentation within one or more display screens the corresponding digital interface, such as digital interface 220. In some instances, digital interface 220 may be associated with the initiated chat session, and digital interface 220 may be disposed within one or more display screens or panes of an additional digital interface associated with executed mobile application, and additionally, or alternatively, may represent a pop-up window that, upon presentation by display unit 112, obscures a portion of the additional digital interface. For example, as illustrated in FIG. 2A, digital interface 220 may include interface element 218A that presents the session identifier of the initiated chat session (e.g., an alphanumeric character string “1AX772”), interface element 218B that indicates an initiation of the chat session at 10:15 a.m. on Apr. 16, 2025 (e.g., “10:15/2025-04-16”), and interface elements 218C that confirm the initiation of the chat session between user 101 and agent 151 (e.g., “Welcome to the chat session between USERID and AGENTID”). Further, as illustrated in FIG. 2A, digital interface 220 may also include an additional interface element, such as text box 222, available to receive input from user 101 (e.g., via input unit 114) that specifies a message within the ongoing chat session between user 101 and agent 151.

Further a programmatic interface established and maintained by agent device 152, such as API 224 associated with executed agent desktop application 158, may receive the elements of initiation data 216 across network 140 from computing system 130, and may route the elements of initiation data 216 to executed agent desktop application 158. Executed agent desktop application 158 may, for example, store the elements of initiation data 216 within a corresponding portion of a data repository accessible to executed agent desktop application 158, such as within a portion of memory 156, and executed agent desktop application 158 may perform operations that generate one or more interface elements 226 of a corresponding digital interface associated with the initiated chat session, such as, but not limited to, the exemplary interface elements described herein. In some instances, executed agent desktop application 158 may populate each of interface elements 226 with a corresponding portion of the elements of initiation data 216, and executed agent desktop application 158 may provide interface elements 226 to display unit 160, which may render interface elements 226 for presentation within one or more display screens the corresponding digital interface, such as digital interface 228.

In some instances, digital interface 228 may also be associated with the secure, programmatic chat session, and digital interface 228 may be disposed within one or more display screens or panes of an additional digital interface associated with executed agent desktop application 158, and additionally, or alternatively, may represent a pop-up window that, upon presentation by display unit 112, obscures a portion of the additional digital interface. For example, as illustrated in FIG. 2A, digital interface 228 may include interface element 226A that presents the session identifier of the initiated chat session (e.g., an alphanumeric character string “1AX772”), interface element 226B that indicates an initiation of the chat session at 10:15 a.m. on Apr. 16, 2025 (e.g., “10:15/2025-04-16”), and interface elements 226C that confirm the initiation of the chat session between user 101 and agent 151 (e.g., “Welcome to the chat session between USERID and AGENTID”). Further, as illustrated in FIG. 2A, digital interface 228 may also include an additional interface element, such as text box 230, available to receive input from user 101 (e.g., via input unit 114) that specifies a message within the secure, programmatic chat session between user 101 and agent 151.

Based on input provisioned to respective ones of text box 222 of digital interface 220 and text box 230 of digital interface 228 (e.g., via respective ones of input unit 114 and input unit 162), user 101 and agent 151 may exchange messages during the secure, programmatic chat session established between executed mobile application 108, executed chat server 142, and executed agent desktop application 158. For example, based on messages exchanged between the user 101 and agent 151 during the secure, programmatic chat session, the user 101 may elect to apply for a wallet-compatible product available for provisioning by the organization. As described herein, examples of the wallet-compatible product may include, but are not limited to, a payment instrument, a loyalty or rewards account, a government-issued identifier (such as a driver's license, etc.), a medical credential (e.g., a vaccination record), a transit passe (e.g., a Presto™ card, etc.), and a stored-value card associated with a corresponding retailer (e.g., a Starbucks™ gift cards, etc.). In some instances, and through the secure, programmatic chat session established between executed mobile application 108, executed chat server 142, and executed agent desktop application 158, computing system 130 (and approval system 170) may perform any of the exemplary processes described herein to provision a digitally signed data packet that includes secure account credentials of the wallet-compatible product to client device 102 in real-time (or in near-real-time) and contemporaneously with an issuance of the of the wallet-compatible product to user 101.

Referring to FIG. 2B, user 101 may provide input 234 to text box 222 of digital interface 220 (e.g., via the input unit 114 of the customer device) that specifies the intention of user 101 to apply for the available, wallet-compatible product (e.g., a payment instrument available for provisioning by the organization, etc.), and input unit 114 may route corresponding elements of input data 236 to executed mobile application 108. In some instances, the elements of input data 236 may include textual content that indicates the intention of user 101 to obtain the available, wallet-compatible product (e.g., “I'd like to apply for a new credit card”), and in some instances, executed mobile application 108 may process the elements of input data 236 and generate corresponding interface elements 238 for presentation within digital interface 220, e.g., via display unit 112. Executed mobile application 108 may also perform operations that package the elements of input data 236, a unique session identifier 237 of the secure, programmatic chat session, and a unique user identifier 239 of user 101 into corresponding portions of message data 240. Further, executed mobile application 108 may also perform any of the exemplary processes described herein to apply a digital signature to all, or a selected portion, of message data 240, and executed mobile application 108 may cause client device 102 to transmit message data 240, and in some instances, the applied digital signature, across network 120 to computing system 130.

In some instances, API 204 associated with executed chat server 142 may receive message data 240 and the applied digital signature, and API 204 may provide message data 240 and the applied digital signature as inputs to executed authentication module 206, which may perform any of the exemplary processes described herein to verify an authenticity or an integrity of message data 240 based on a validation of the applied digital signature. If, for example, executed authentication module 206 were unable to verify the integrity or the authenticity of message data 240, executed chat server 142 may reject message data 240, and executed authentication module 206 may transmit elements of notification data that confirm the rejection of message data 240 across network 120 to client device 102 (not illustrated in FIG. 2A). Alternatively, if executed authentication module 206 were to validate the integrity or the authenticity of message data 240, executed authentication module 206 may provide message data 240 as an input to a session management module 242 of executed chat server 142, which may store temporal identifier 244 specifying a time or date of a receipt of message data 240 and all or a selected portion of message data 240 (including the elements of input data 236, session identifier 237, and user identifier 239) within a data repository accessible to computing system 130, such as, but not limited to, within chat session data store 138 of data repository 132.

Executed session management module 242 may also perform operations that cause computing system 130 to transmit message data 240 across network 140 to agent device 152 (e.g., based on the device identifier associated with agent device 152 and with session identifier 237). In some instances, API 224 associated with executed agent desktop application 158 may receive message data 240 and may store all, or a selected portion, of message data 240 within a data repository accessible to executed agent desktop application 158, such as within a portion of memory 156 (not illustrated in FIG. 2B). Further, and based on the elements of input data 236, executed agent desktop application 158 may generate one or more interface elements 246 that, when rendered for presentation within digital interface 228 (e.g., via display unit 160), indicate the intention of user 101 to obtain the wallet-compatible product (e.g., the new credit card) during the secure, programmatic chat session.

In some instances, based on the intention of user 101 to obtain the wallet-compatible product, agent 151 and user 101 may exchange additional elements of message data (e.g., within the secure, programmatic chat session established between executed mobile application 108, executed chat server 142, and executed agent desktop application 158) that enables agent 151 to confirm the intention of user 101 to obtain the wallet-compatible product and to further verify the identity of user 101. For example, through these additional exchanges of message data within the secure, programmatic chat session, agent 151 may request and receive from user 101 answers to one or more challenge questions selected by user 101 upon registration of mobile application 108 with computing system 130, which agent 151 may compare against elements of customer profile data maintained securely memory 156. In other examples, executed agent desktop application 158 may push an text or email message to client device 102 that, when presented within a corresponding digital interface by display unit 112, prompts user 101 to enter a specified, alphanumeric challenge code within the text box 222, and agent 151 may verify the accuracy of the entered, alphanumeric challenge code once received and presented within a corresponding portion of digital interface 228, e.g., through a performance of one or more of the exemplary processes described herein during the secure, programmatic chat session established between executed mobile application 108, executed chat server 142, and executed agent desktop application.

Additionally, in some instances, agent 151 and user 101 may exchange further elements of message data (e.g., within the secure, programmatic chat session established between executed mobile application 108, executed chat server 142, and executed agent desktop application 158) that enables agent 151 to obtain additional information that facilitates, and supports, an application for the wallet-compatible product on behalf of user 101. For example, the additional information may include, but is not limited to, a full legal name of user 101, a mailing address of user 101, a governmental identifier assigned to user 101 (e.g., a driver's license number, a social security number, etc.), a date of birth, and financial data associated with user 101, such as, but not limited to, a current employer and current income of user 101. The disclosed embodiments are, however, not limited to these additional and further elements of message data, and in other examples, agent 151 and user 101 may exchange any additional, or alternate, elements of message data (e.g., within the secure, programmatic chat session established between executed mobile application 108, executed chat server 142, and executed agent desktop application 158) that facilitate the application for the wallet-compatible product on behalf of user 101.

Referring to FIG. 2C, executed chat server 142 may perform any of the exemplary processes described herein to receive each of the additional or further elements of message data from client device 102 across network 120, to verify an authenticity and an integrity of each of the additional or further elements of message data, and to transmit each of the additional or further elements of message data (e.g., as additional or further elements of message data 250) across network 140 to agent device 152. In some instances, API 224 associated with executed agent desktop application 158 may receive the additional or further elements of message data 250, and API 224 may provide the additional or further elements of message data 250 as inputs to executed agent desktop application 158. Although not illustrated in FIG. 2C, executed agent desktop application 158 may store all, or a selected portion, of message data 250 within a data repository accessible to executed agent desktop application 158 (e.g., within a portion of memory 156) and may generate one or more interface elements that, when rendered for presentation within digital interface 228 (e.g., via display unit 160), provide a representation of the additional or further elements of message data 250 exchanged during the secure, programmatic chat session.

Executed agent desktop application 158 may also perform one or more of the exemplary processes described herein to generate, based on the additional or further elements of message data 250, one or more elements of application data 252 that identify and characterize the customer and the wallet-compatible product available for provisioning by approval system 170. The elements of application data 252 may, for example, correspond to an application for the wallet-compatible product on behalf of user 101, and the elements of application data 252 may include, but are not limited to, a unique product identifier of the wallet-compatible product (e.g., a name of the wallet-compatible product, an alphanumeric identifier, etc.), the full legal name of user 101, the mailing address of user 101, the governmental identifier assigned to user 101, the date of birth of user 101, and portions of the financial data associated with user 101.

In some instances, executed agent desktop application 158 may generate the elements of application data 252 based on the elements of message data 240 and 250 maintained within memory 156 and additionally, or alternatively, based on elements of profile data that identify and characterize user 101, e.g., as maintained within profile data store 136 of computing system 130 or as maintained locally within memory 156. For example, executed agent desktop application 158 may access template data that characterizes a structure and a composition of an application template associated with the wallet-compatible product and approval system 170, and based on the template data, executed agent desktop application 158 may perform operations that populate the application template with corresponding elements of message data 240 and 250 and additionally, or alternatively, with the corresponding elements of profile data, and that package the populated application template into corresponding portions of application data 252. As illustrated in FIG. 2C, executed agent desktop application 158 may perform operations that cause agent device 152 to transmit the elements of application data 252 across network 140 to approval system 170, which may perform any of the exemplary processes described herein to apply one or more adjudication criteria to the elements of application data 252 and based on a successful adjudication, provision a digitally signed data packet that includes the secure account credentials of the wallet-compatible product to client device 102 during the secure, programmatic chat session.

Additionally, or alternatively, agent 151 may access, via executed agent desktop application 158 of agent device 152, a digital portal of approval system 170, and executed agent desktop application 158 may generate the elements of application data 252 based on input provisioned to one or more interface elements of the accessed digital portal by agent 151 (e.g., via input unit 162). By way of example, the digital portal may correspond to web page associated with, and maintained by, approval system 170, and executed agent desktop application 158 may generate one or more programmatic instructions that trigger an execution of a web browser by processor 154 of agent device 152. For instance, upon accessing the digital portal presented by display unit 160, agent 151 may provide input, via input unit 162, that specifies one or more authentication credentials of agent 151, such as, but not limited to, an alphanumeric login and password or one or more biometric credentials (e.g., a fingerprint scan or a facial image, etc.). Upon authentication of the authentication credentials, the digital portal may present, to agent 151 via display unit 160, one or more interface elements that identify corresponding ones of the wallet-compatible products available for provisioning to user 101, such as, but not limited to, the exemplary wallet-compatible products described herein.

Agent 151 may provide input to the presented digital portal (e.g., via input unit 162 of agent device 152) that selects the wallet-compatible product requested by user 101 during the secure, programmatic chat session (e.g., the requested credit card, etc.), and agent 151 may provide further input to input unit 162 that initiates, completes, and requests a submission of a corresponding application to approval system 170, e.g., the elements of application data 252 described herein. For example, in step 3, agent 151 may provide, via input unit 162 to one or more interface elements of the presented digital portal, elements of application data 252 that identify or characterize the wallet-compatible product and user 101, such as, but not limited to, the unique product identifier of the wallet-compatible product, the full legal name of user 101, the mailing address of user 101, the governmental identifier assigned to user 101, the date of birth of user 101, and portions of the financial data associated with user 101. In some instances, based on additional input provisioned to input unit 162, agent 151 may request that agent device 152 submit the application to approval system 170, and based on the additional input, executed agent desktop application 158 may perform operations that cause agent device 152 to transmit the elements of application data 252 across network 140 to approval system 170.

Referring back to FIG. 2C, a programmatic interface established and maintained by approval system 170, such as an API 254 associated with adjudication engine 178, may receive the elements of application data 252 and may provide the elements of application data 252 as inputs to adjudication engine 178, which, upon execution by the one or more processors of approval system 170, may perform any of the exemplary processes described herein to approve, or alternatively, reject, the application for the available, wallet-compatible product on behalf of user 101. For example, executed adjudication engine 178 may receive the elements of application data 252 from API 254 and may store the received elements of application data 252 with an accessible data repository, such as within data repository 172 (not illustrated in FIG. 2C). Executed adjudication engine 178 may also obtain, from the elements of application data 252, a unique product identifier 256 of the wallet-compatible product (e.g., the name of the wallet-compatible product, that alphanumeric identifier, etc.), and based on product identifier 256, executed adjudication engine 178 may obtain adjudication criteria 258 associated with product identifier 256 and as such, with the wallet-compatible product.

In some instances, adjudication criteria 258 may specify customer-and product-specific criteria that inform not only an approval, or alternatively, a rejection, of the application for the wallet-compatible product, but also a determination of an initial set of terms and conditions associated with the wallet-compatible product in response to the approval of the application. By way of example, the wallet-compatible product may include a credit card approved and issued by the organization, and the initial set of terms and conditions may include an initial credit limit or an initial interest rate. Further, examples of the customer-specific criteria may include a restriction on a customer age (e.g., limiting provisioning of wallet-compatible products to customers over eighteen years or age, etc.) or a restriction on a customer location (e.g., limiting provisioning of wallet-compatible products to customers having addresses within certain geographic regions, etc.), and examples of the product-specific restrictions may include an income-specific restriction on certain wallet-compatible products (e.g., limiting provisioning of a certain wallet-compatible product to customers having incomes that exceed a threshold value, specifying initial terms and conditions for certain ranges of incomes, etc.) or one or more restrictions associated with customer creditworthiness (e.g., limiting provisioning of a certain wallet-compatible product to customers having credit scores in excess of a threshold score, specifying initial terms and conditions for certain ranges of credit scores, etc.).

In some instances, executed adjudication engine 178 may perform operations that apply each of adjudication criteria 258 to corresponding ones of the elements of application data 252 and additionally, to elements of additional data 260 that characterize a relationship of user 101 with the organization or with other unrelated organizations, and/or that characterize the use, or misuse, of wallet-compatible products provisioned to user 101 by the organization or by the unrelated organizations. The elements of additional data 260 may be maintained securely within a portion of data repository 172, and examples of the elements of additional data 260 may include, but are not limited to, elements of reporting data, such as the customer's credit report or corresponding credit score, and elements of account or transaction data identifying one or more additional wallet-compatible products provisioned to user 101 by approval system 170 and characterize the use, or misuse, of these additional wallet-compatible products by user 101.

If, based on the application of the more card-specific qualification or underwriting processes to the elements of application data 252 and/or additional data 260, executed adjudication engine 178 were to reject the application for the wallet-compatible product, executed adjudication engine 178 may perform operations (not illustrated in FIG. 2C) that transmit a notification indicating the rejection of the application to agent device 152 across the network 140. In some instances, executed agent desktop application 158 may receive the notification via API 224, and executed agent desktop application 158 may generate and transmit additional elements of message data, which indicate the rejection of the application, across network 140 to computing system 130, e.g., within the secure, programmatic chat session established between executed mobile application 108, executed chat server 142, and executed agent desktop application 158. In some instances, executed chat server 142 may perform any of the exemplary processes described herein to store the additional elements of message data within a portion of chat session data store 138 (e.g., as additional session data associated with session identifier 237 of the secure, programmatic chat session) and to route the additional elements of message data across network 120 to client device 102. As described herein, API 217 may receive the additional elements of message data within the secure, programmatic chat session and may route the additional elements of message data to executed mobile application 108, which may perform any of the exemplary processes described herein to present content indicating the rejection of the application within a corresponding portion of digital interface 220 during the secure, programmatic chat session established between executed mobile application 108, executed chat server 142, and executed agent desktop application 158.

Alternatively, if executed adjudication engine 178 were to approve the application for the wallet-compatible product based on the application of the more card-specific qualification or underwriting processes to the elements of application data 252 and/or additional data 260, executed adjudication engine 178 may generate elements of approval data 264 that confirm the approval of the application for the wallet-compatible product and in some instances, that specify the initial set of terms and conditions associated with the wallet-compatible product. In some instances, executed adjudication engine 178 may store the elements of approval data 264 and product identifier 256 of the wallet-compatible product within a corresponding portion of instrument data store 176 (not illustrated in FIG. 2C).

Further, as illustrated in FIG. 2C, executed adjudication engine 178 may provide the elements of approval data 264 as inputs to a provisioning engine 180 executed by the one or more processors of approval system 170. Upon receipt of the elements of approval data 264, executed provisioning engine 180 may perform any of the exemplary processes described herein to approve the wallet-compatible product for user 101 in accordance with the elements of application data 252 and in some instances, in accordance with the initial set of terms and conditions specified within the elements of approval data 264. Further, executed provisioning engine 180 may also perform any of the exemplary processes described herein to generate a digitally signed, secure data package that includes account credentials for the approved, wallet-compatible product, which may be provisioned to executed wallet application 110 in real-time, and contemporaneously with the issuance of the wallet-compatible product, during the secure, programmatic chat session established between executed mobile application 108, executed chat server 142, and executed agent desktop application 158.

By way of example, executed provisioning engine 180 may perform operations that generate one or more account credentials 266 for the wallet-compatible product, and examples of these account credentials include, but are not limited to, an account number, a tokenized account number (e.g., suitable for reproduction within a physical card, etc.), a card-verification code, and an expiration date. The format or structure of the account number (e.g., sixteen digits, etc.) and the verification code (e.g., three or four digits, etc.) may be specific to the wallet-compatible product (e.g., the approved credit card, etc.). In some instances, executed provisioning engine 180 may store account credentials 266 within a corresponding portion of instrument data store 176, e.g., in conjunction with the unique identifier of user 101 (e.g., identifier 239, as described herein) and product identifier 256 of the wallet-compatible product.

Executed provisioning engine 180 may also perform operations that generate a secure data package 268 that facilitates an addition of the approved, wallet-compatible product to the digital wallet of user 101, which may be maintained by executed wallet application 110 within a secure memory partition of memory 106 of client device 102 (e.g., a secure element of the customer's iPhone™ device). By way of example, executed provisioning engine 180 may perform operations that generate, or obtain from an additional computing system associated with a token service provider (TSP) across network 140, a digital token associated with the account number of the wallet-compatible product and a corresponding public key associated with the digital token. By way of example, the approved wallet-compatible product may correspond to a credit card, the digital token associated with the account number of the credit card may include a payment token, and further, the public key associated with the payment token may correspond to a payment-token key.

Executed provisioning engine 180 may package the digital token associated with the account number of the wallet-compatible product, the public key associated with the digital token, and in some instances, an additional public key associated with the card verification code (e.g., a CVV key) into corresponding portions of the secure data package 268. Further, executed provisioning engine 180 may also perform any of the exemplary processes described herein to that apply an appropriate digital signature 270 to secure data package 268 (e.g., to generate a digitally signed, secure data package 272), and executed provisioning engine 180 may also cause approval system 170 to transmit digitally signed, secure data package 272 across network 140 to agent device 152.

In some instances, executed provisioning engine 180 may also obtain one or more elements of digital content 274 associated with the wallet-compatible product (e.g., from one or more tangible, non-transitory memories of approval system 170, from one or more further computing systems accessible to approval system 170 across network 140, etc.), and may perform operations that cause approval system 170 to transmit digitally signed, secure data package 272 and the elements of digital content 274 across network 140 to agent device 152. Although not illustrated in FIG. 2C, executed provisioning engine 180 may also perform operations that initiate a generation of the physical instrument associated with the wallet-compatible product (e.g., a physical card, etc.) and a mailing of that physical instrument to the address of user 101 (e.g., as maintained within the elements of application data 252). In some examples, through the transmission of the digitally signed, secure data package 272 across network 140 to agent device 152, one or more of the exemplary processes described herein may inject the digitally signed, secure data package 272 into the secure, programmatic chat session established between executed mobile application 108, executed chat server 142, and executed agent desktop application 158, and may facilitate a provisioning of wallet-compatible product to executed wallet application 110, in real-time and contemporaneously with the issuance of the wallet-compatible product, and without requiring a possession of the physical instrument by user 101.

Referring to FIG. 2D, API 224 associated with executed agent desktop application 158 may receive digitally signed, secure data package 272 and in some instances, the elements of digital content 274 across network 140 from approval system 170, and API 224 may route digitally signed, secure data package 272 and the elements of digital content 274 to executed agent desktop application 158. In some instances, upon receipt of digitally signed, secure data package 272 and the elements of digital content 274, or based on additional input provisioned to digital interface 228 by agent 151 (e.g., via the corresponding input unit 162), executed agent desktop application 158 may perform operations that inject digitally signed, secure data package 272 and the elements of digital content 274 into the secure, programmatic chat session established between executed mobile application 108, executed chat server 142, and executed agent desktop application 158. For example, executed agent desktop application 158 may generate elements of message data 276 that include session identifier 237, an agent identifier 277 of agent 151 (e.g., an alphanumeric identifier, etc.), digitally signed, secure data package 272 and the elements of digital content 274, and executed agent desktop application 158 may cause agent device 152 to transmit the elements of message data 276 across the network 140 to computing system 130.

A programmatic interface established and maintained by computing system 130, such as API 204 associated with executed chat server 142, may receive the elements of message data 276, which includes session identifier 237, agent identifier 277, digitally signed, secure data package 272 and the elements of digital content 274, and may route the elements of message data 276 to executed chat server 142. In some instances, authentication module 206 of executed chat server 142 may receive the elements of message data 276, and executed authentication module 206 may perform any of the exemplary processes described herein to verify an authenticity or an integrity of message data 276 based on a validation of the digital signature 270 applied to secure data package 268, e.g., within digitally signed, secure data package 272. Further, and based on an successful validation of digital signature 270, executed authentication module 206 may provide message data 240 as an input to session management module 242 of executed chat server 142, which may store temporal data specifying a time or date of a receipt of message data 276 and all or a selected portion of message data 276 (including session identifier 237, agent identifier 277, digitally signed, secure data package 272 and the elements of digital content 274) within a data repository accessible to computing system 130, such as, but not limited to, within chat session data store 138 of data repository 132 (not illustrated in FIG. 2D).

Executed session management module 242 may also perform operations that cause computing system 130 to transmit message data 276 across network 120 to client device 102 (e.g., based on the device identifier associated with client device 102 and with session identifier 237). In some instances, a programmatic interface established and maintained by client device 102, such as API 217 associated with executed mobile application 108, may receive the elements of message data 276 across network 120 from computing system 130, and may route the elements of message data 276 to executed mobile application 108. Executed mobile application 108 may, for example, perform any of the processes described herein to verify an authenticity or an integrity of message data 276 based on a validation of digital signature 270 applied to secure data package 268, e.g., within digitally signed, secure data package 272.

Based on a validation of digital signature 270 applied to secure data package 268, executed mobile application 108 may obtain the elements of digital content 274 associated with the wallet-compatible product from message data 276. As described herein, the elements of digital content 274 may provide a graphical representation that identifies the wallet-compatible product and in some instances, the elements of digital content 274 may include an image of a portion of a physical instrument associated with the wallet-compatible product. Executed mobile application 108 may also perform operations that generate one or more elements of textual content 280 confirming the issuance of the wallet-based instrument (e.g., the credit card, etc.) and indicating that the newly approved wallet-based instrument is ready for addition into a digital wallet 282 of user 101 maintained within secure partition 284 of memory 106 by executed wallet application 110.

As illustrated in FIG. 2D, executed mobile application 108 may provide each, or a selected subset, of the elements of digital content 274 and of the elements of textual content 280 to display unit 112 of client device 102, which may present the provisioned elements of digital content 274 and textual content 280 within one or more portions of digital interface 220. In some instances, display unit 112 may present the provisioned elements of digital content 274 and textual content 280 within one or more display screens of digital interface 220, or alternatively, display unit 112 may present the provisioned elements of digital content 274 and textual content 280 within a pop-up window or other window that obscures at least a portion of the digital content presented within digital interface 220.

As described herein, the presented elements of textual content 280 may prompt user 101 to provide additional input to input unit 114 that authorizes expressly the addition of the wallet-compatible product to digital wallet 282. For example, the presented elements of textual content 280 may prompt user 101 to provide specific alphanumeric character string as input to text box 222 that authorizes or blocks the addition of the wallet-compatible product to digital wallet 282, such as the alphanumeric character string “YES” to add the wallet-compatible product to digital wallet 282 or the alphanumeric character string “NO.” In other examples, the digital interface 220 may include one or more interface elements (e.g., selectable elements labelled “YES” or “NO,” etc.) that, when selected by user 101 based on input provided to input unit 114, indicate an intention by user 101 to add, or alternatively, to block the addition of, the wallet-compatible product to digital wallet 282. The disclosed embodiments are, however, not limited to these exemplary processes for authorizing expressly the addition of the wallet-compatible product to digital wallet 282, and in other examples, user 101 may provide any additional, or alternate, input to input unit 114 that authorizes, or blocks, the addition of the wallet-compatible product to digital wallet 282, such as, but not limited to, voice or tactile input.

Referring back to FIG. 2D, user 101 may elect to the wallet-compatible product to digital wallet 282, and may provide, to input unit 114, any of the exemplary input described herein to authorize the additional the wallet-compatible product to digital wallet 282, e.g., as input 283. In some instances, input unit 114 may receive input 283, and may route corresponding elements of input data 286 indicative of the authorized addition of the wallet-compatible product to digital wallet 282 to executed mobile application 108. Based on the elements of input data 286, executed mobile application 108 may provide digitally signed, secure data package 272 as an input to executed wallet application 110, which may perform any of the exemplary processes described herein to validate digital signature 270 applied to secure data package 268, e.g., within digitally signed, secure data package 272. Further, and based on the validation of digital signature 270, executed wallet application 110 may store secure data package 268, which includes the digital token associated with the account number of the wallet-compatible product, the public key associated with the digital token, and in some instances, an additional public key associated with the card verification code, within secure partition 284 of memory 106 (e.g., a secure element of an iPhone™ device). Upon storage of secure data package 268 within secure partition 284 of memory 106, the wallet-compatible product is added to digital wallet 282 and is available for use in contactless or digital transactions via executed wallet application 110.

In some instances, executed mobile application 108 and executed wallet application 110 may perform any of the exemplary processes described herein that add the mobile-compatible instrument to digital wallet 282 of user 101 in response to additional input that expressly authorizes the addition of the mobile-compatible instrument to digital wallet 282. These disclosed embodiments are, however, not limited to processes that add mobile-compatible instrument to digital wallet 282 in response to an express authorization by user 101, and in in other examples, executed mobile application 108 and executed wallet application 110 may perform any of the exemplary processes described herein that add the mobile-compatible instrument to digital wallet 282 of user 101 without express authorization by user 101 and upon receipt of the elements of message data 276 and a successful validation of digital signature 270 applied to secure data package 268.

Further, certain of the exemplary processes described herein, which may be implemented by client device 102, computing system 130, agent device 152, and approval system 170 within the secured chat session established between executed mobile application 108, executed chat server 142, and executed agent desktop application 158, may rely on the security associated with, and imposed upon the participants in, the secure, programmatic chat session to facilitate a provisioning of a wallet-compatible product to digital wallet 282 maintained by executed wallet application 110 in real-time and contemporaneously with the issuance of the wallet-compatible product, and without requiring a possession of the physical instrument by user 101. These exemplary processes represent a specific, technological improvement to existing provisioning processes, which rely on a possession of a physical instrument by user 101 to provide an additional level of security for secure account credentials of the wallet-compatible product.

As described herein, session initiation module 208 of executed chat server 142 may generate a unique session identifier for a secure, programmatic chat session initiated by executed mobile application 108 at client device 102 and may perform operations that allocate the secure, programmatic chat session to an available agent of the organization, such as, but not limited to, agent 151 associated with agent device 152. In some instances, the secure, programmatic chat session between executed mobile application 108 at client device 102, executed chat server 142 of computing system 130, and executed agent desktop application 158 of agent device 152 may facilitate direct chat-based communication between client device 102 and agent device 152 despite the inaccessibility of network 140 to client device 102.

The disclosed embodiments are, however, not limited to processes that allocate the secure, programmatic chat session to an available agent of the organization, and in additional or alternative examples, executed session initiation module 208 may also perform operations that allocate the secure, programmatic chat session to a programmatic chatbot associated with the organization, such as, but not limited to, an interactive chatbot established by chatbot engine 144 upon execution by the one or more processors of computing system 130. Based on the allocation of the secure, programmatic chat session to the interactive chatbot, executed session initiation module 208 may perform additional operations that trigger an execution of chatbot engine by the one or more processors of computing system 130. For example, executed chatbot engine 144 may perform any of the exemplary processes described herein to process elements of message data received from executed mobile application 108 of client device 102 within the secure, programmatic chat session, to adaptively and dynamically parse the elements of message data to establish a meaning and/or a context of the message data and further, to generate and provision, to executed mobile application 108, a response to each of the elements of message data via a secure, programmatic interface, such API 217. In some instances, when presented to user 101 within digital interface 220 (e.g., via display unit 112 of client device 102), the presented responses may simulate an ongoing and contextually relevant dialog between user 101 and the artificially, and programmatically generated, interactive chatbot.

In some instances, executed chatbot engine 144 may apply one or more adaptive, statistical, or dynamic natural language processing (NLP) algorithms to the received elements of message data. Based on the application of these adaptive, statistical, or dynamic NLP algorithms, executed chatbot engine 144 may parse the received elements of message data to identify one or more discrete linguistic elements (e.g., a word, a combination of morphemes, a single morpheme, etc.), and to generate contextual information that establishes the meaning or a context of one or more discrete linguistic elements. Examples of these NLP algorithms may include one or more machine learning processes, such as, but not limited to, a clustering algorithm or unsupervised learning algorithm (e.g., a k-means algorithm, a mixture model, a hierarchical clustering algorithm, etc.), a semi-supervised learning algorithm, or a decision-tree algorithm. In other examples, the one or more NLP algorithms may also include one or more artificial intelligence models, such as, but not limited to, an artificial neural network model, a recurrent neural network model, a Bayesian network model, or a Markov model. Further, the one or more NLP algorithms may also include one or more statistical processes, such as those that make probabilistic decisions based on attaching real-valued weights to elements of certain input data. Additionally, in some instances, the one or more NLP algorithms may include a large language model (LLM) or a generative, pre-trained transformed (GPT) process. Certain of these exemplary NLP processes can be trained against, and adaptively improved using, training data having a specified composition, which may be extracted from the data records of profile data store 136 and chat session data store 138, and can be deemed successfully trained and ready for deployment when a model accuracy (e.g., as established based on a comparison with the outcome data), exceeds a threshold value.

Further, and based on the allocation of the secure, programmatic chat session to the interactive chatbot, executed chatbot engine 144 may perform operations that cause computing system 130 to perform any of the exemplary processes described herein to generate elements of application in support of an application for a wallet-compatible product on behalf of user 101, to transmit the elements of application data across network 140 to approval system 170, and based on an approval of the application, to receive, from approval system 170 across network 140, a digitally signed, secure data package that includes account credentials for the approved, wallet-compatible product. In some instances, and based on an validation of a corresponding digital signature, executed chatbot engine 144 may generate, and transmit across network 120 to client device 102, one or more programmatically generated messages that inject the digitally signed, secure data package into the secure, programmatic chat session established between executed mobile application 108 and executed chat server 142, which may facilitate a provisioning of wallet-compatible product to executed wallet application 110 in real-time and contemporaneously with the issuance of the wallet-compatible product, and without requiring a possession of the physical instrument by user 101.

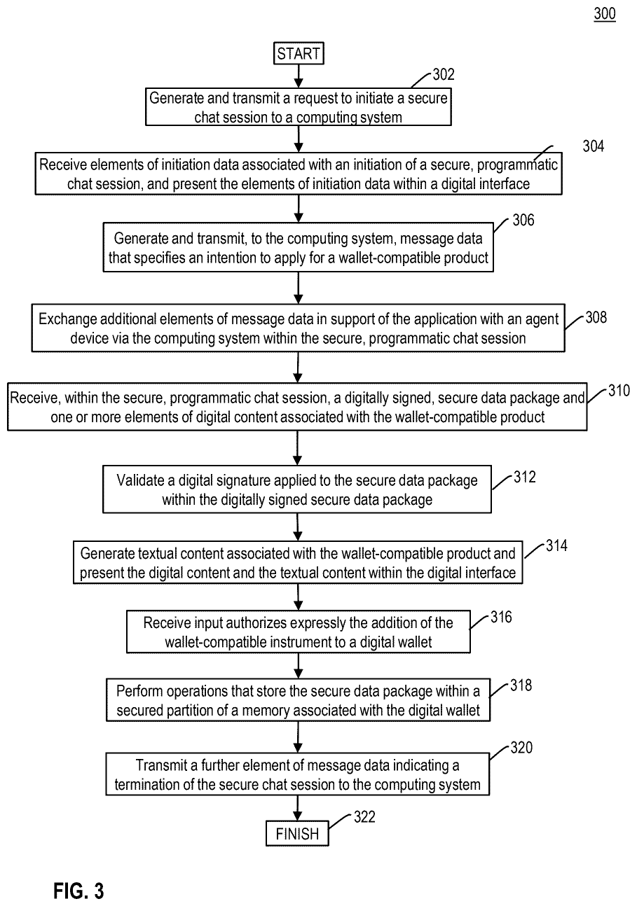

FIGS. 3, 4, and 5 are flowcharts of exemplary processes for provisioning a wallet-compatible product into a digital wallet using a secure, programmatic chat session, in accordance with some exemplary embodiments. As described herein, the secure, programmatic chat session may be established between a first application program executed at a first device (e.g., mobile application 108 executed by processor 104 of client device 102), a chat server executed at a computing system (e.g., chat server 142 executed by the one or more processors of computing system 130), and a second application program executed at a second device (e.g., agent desktop application 158 executed by processor 154 of agent device 152). Further, and as described herein, the first device and the second device may be interconnected across a first communications network (e.g., network 120), and the computing system and the second device may be interconnected by a second communications network, which may be inaccessible to the first device. In some instances, the secure, programmatic chat session may, for example, facilitate direct chat-based communication between first and second devices despite an inaccessibility of the second communications network to the first device.

Further, one or more of the exemplary processes described herein may facilitate an injection of a digitally signed, secure data package associated with the wallet-compatible product into the secure, programmatic chat session established between the executed first application program, the executed chat server, and the executed second application, and may facilitate a provisioning of the provisioning of wallet-compatible product to wallet application executed at the first device in real-time and contemporaneously with an issuance of the wallet-compatible product to a user, and without requiring a possession of the physical instrument associated with the wallet-compatible product by that user. In some instances, the first device (e.g., client device 102) may perform one or more of the steps of exemplary process 300, the computing system (e.g., one or more distributed computing components of computing system 130) may perform one or more of the steps of exemplary process 400, and the second device (e.g., agent device 152) may perform one or more of the steps of exemplary process 500.

Referring to FIG. 3, client device 102 may perform any of the exemplary processes described herein to generate a request to initiate a secure, programmatic chat session with an agent of an organization and to transmit the generated request across network 120 to computing system 130 associated with the organization (e.g., in step 302 of FIG. 3). As described herein, the agent may correspond to agent 151 associated with agent device 152, although in other examples, the agent may correspond to an interactive chatbot of the organization, which may be generated programmatically by the one or more processors of computing system 130, e.g., by executed chatbot engine 144. In some instances, client device 102 may generate the request in response to elements of input provisioned to client device 102 by a corresponding user, such as user 101, via input unit 114, and as described herein, the request by be generated by an application program executed at client device 102. Further, and as described herein, the request may include, one or more of the authentication credentials of user 101, an identifier of executed mobile application 108 (e.g., an application cryptogram or token of specified format a, etc.), an identifier of client device 102 (e.g., an IP or MAC address, etc.), and in some instances, elements of data that confirm the successful authentication of an identity of user 101, such as, but not limited to, a digital signature applied to the request.

In some instances, and upon receipt of the request and the digital signature applied to the request, computing system 130 may perform any of the exemplary processes described herein to validate the digital signature applied to the request and based on the validation of the applied digital signature, computing system 130 may generate a unique session identifier for the secure, programmatic chat session associated with the request and may perform any of the exemplary processes described herein to allocate the secure, programmatic chat session associated with the request to an available agent of the organization (e.g., to agent 151 associated with agent device 152, to an interactive chatbot generated programmatically by executed chatbot engine 144, etc.). Further, and through a performance of one or more of the exemplary operations described herein, computing system 130 may initiate the secure, programmatic chat session between client device 102, computing system 130, and agent device 152 (and additionally, or alternatively, the interactive chatbot), and computing system 130 may transmit elements of initiation data across network 120 to client device 102 and further, across network 140 to agent device 152.

Referring back to FIG. 3, client device 102 may receive the elements of initiation data across network 120 from computing system 130, and client device 102 may perform any of the exemplary processes described herein to present portions of the received elements of initiation data within a corresponding digital interface, such as, but not limited to, digital interface 220 associated with executed mobile application 108 (e.g., in step 304 of FIG. 3). As described herein, the elements of initiation data may include the unique session identifier of the chat session, temporal data associated with the initiation of the chat session, unique identifiers of the requesting user and the agent, and in some instances, elements of textual content indicating the initiation of the chat session, and in some instances, client device 102 may perform any of the exemplary processes described herein to present the portions of the received elements of initiation data within corresponding interface elements of the digital interface.

Within the initiated, and ongoing, secure, programmatic chat session, client device 102 may receive input from user 101 (e.g., via input unit 114) that specifies an intention of user 101 to apply for a wallet-compatible product available for provisioning by the organization, and based on the received input, client device 102 may perform any of the exemplary processes described herein to generate elements of message data that includes input data characterizing the received input (e.g., textual content specifying the intention of user 101 to apply for the wallet-compatible product), the session identifier, and the identifier of user 101 (e.g., in step 306 of FIG. 3). Examples of the wallet-compatible product may include, but are not limited to, a payment instrument, a loyalty or rewards account, a government-issued identifier (such as a driver's license, etc.), a medical credential (e.g., a vaccination record), a transit passe (e.g., a Presto™ card, etc.), and a stored-value card associated with a corresponding retailer (e.g., a Starbucks™ gift card, etc.). As described herein, client device 102 may also perform any of the exemplary processes described herein to apply a digital signature to the elements of message data, and to transmit the elements of message data and in some instances, the applied digital signature, across network 120 to computing system 130 within the initiated, and ongoing, secure, programmatic chat session (e.g., also in step 306 of FIG. 3).

In some instances, based on the intention of user 101 to apply for the wallet-compatible product, client device 102 may perform any of the exemplary processes described herein to exchange additional elements of message data with agent device 152 via computing system 130 within the initiated, and ongoing, secure, programmatic chat session established between client device 102, computing system 130, and agent device 152 (e.g., in step 308 of FIG. 3). As descried herein, the additional elements of message data exchanged between client device 102 and agent device 152 within the initiated, and ongoing, secure, programmatic chat session may enable agent 151 to confirm the intention of user 101 to obtain the wallet-compatible product, and may enable executed agent desktop application 158 to further verify the identity of user 101 and to obtain additional information that facilitates, and supports, an application for the wallet-compatible product on behalf of user 101.

For example, the additional information may include, but is not limited to, a full legal name of user 101, a mailing address of user 101, a governmental identifier assigned to user 101 (e.g., a driver's license number, a social security number, etc.), a date of birth, and financial data associated with user 101, such as, but not limited to, a current employer and current income of user 101. The disclosed embodiments are, however, not limited to these additional and further elements of message data, and in other examples, agent 151 and user 101 may exchange any additional, or alternate, elements of message data (e.g., within the secure, programmatic chat session established between executed mobile application 108, executed chat server 142, and executed agent desktop application 158) that facilitate the application for the wallet-compatible product on behalf of user 101.

The additional elements of message data exchanged between client device 102 and agent device 152 within the initiated, and ongoing, secure, programmatic chat session may enable agent 151 to confirm the intention of user 101 to obtain the wallet-compatible product, and may enable executed agent device 152 to further verify the identity of user 101 and to obtain additional information that facilitates, and supports, an application for the wallet-compatible product on behalf of user 101. For example, the additional information may include, but is not limited to, a full legal name of user 101, a mailing address of user 101, a governmental identifier assigned to user 101 (e.g., a driver's license number, a social security number, etc.), a date of birth, and financial data associated with user 101, such as, but not limited to, a current employer and current income of user 101. The disclosed embodiments are, however, not limited to these additional and further elements of message data, and in other examples, agent device 152 and user 101 may exchange any additional, or alternate, elements of message data (e.g., within the secure, programmatic chat session established between executed mobile application 108, executed chat server 142, and executed agent desktop application 158) that facilitate the application for the wallet-compatible product on behalf of user 101.

By way of example, based on the additional information and on elements of profile data that identify and characterize user 101, agent device 152 may perform any of the exemplary processes described herein to generate one or more elements of application data that identify and characterize the user 101 and the wallet-compatible product available for provisioning by approval system 170, The elements of application data may, for example, correspond to an application for the wallet-compatible product on behalf of user 101, and in some instances, agent device 152 may transmit the elements of application data across network 140 to approval system 170. As described herein, approval system 170 may perform any of the exemplary processes described herein to apply one or more adjudication criteria to the elements of application data and based on a successful adjudication, to approve the wallet-compatible product for user 101 and to provision, to agent device 152, a digitally signed, secure data packet that facilitates an addition of the approved, wallet-compatible product to the digital wallet of user 101, which may be maintained by executed wallet application 110 within a secure memory partition of memory 106 of client device 102 (e.g., a secure element of the customer's iPhone™ device).

The digitally signed, secure data package may include a secure data package associated with the approved, wallet-compatible product, which stores a digital token associated with the account number of the wallet-compatible product, a corresponding public key associated with the digital token, and in some instances, an additional public key associated with a card verification code of the approved, wallet-compatible product. Further, the digitally signed, secure data package may also include a digital signature, which may be applied to the secure data package by approval system 170 using any of the exemplary processes described herein. In some instances, agent device 152 may transmit elements of message data that include the session identifier, an agent identifier of agent 151 (e.g., an alphanumeric identifier, etc.), the digitally signed, secure data package, and one or more elements of digital content associated with the wallet-compatible product across network 140 to computing system 130 within the initiated, and ongoing, secure, programmatic chat session, and computing system 130 may perform any of the exemplary processes described herein to route the elements of message data to client device 102.

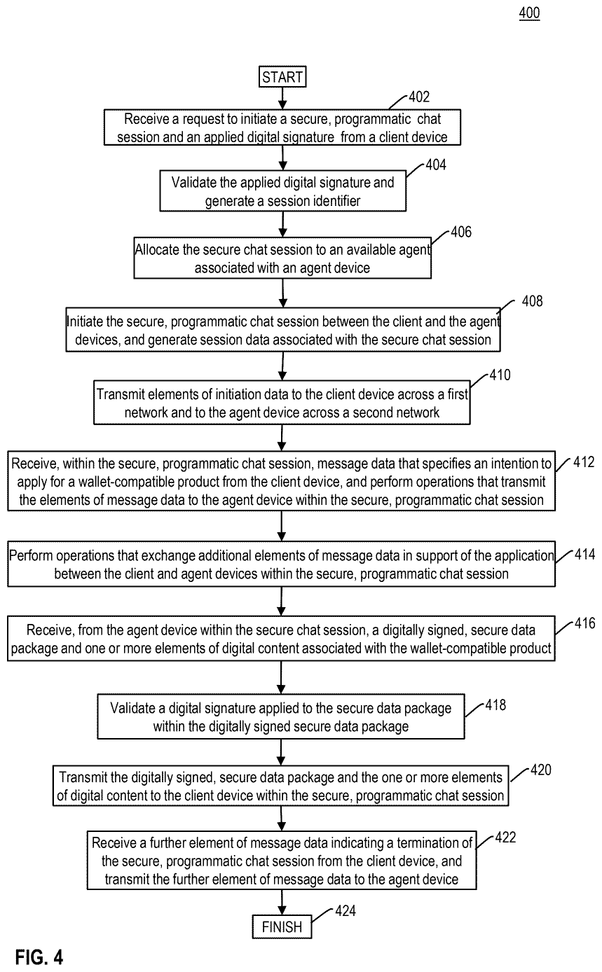

Referring back to FIG. 3, client device 102 may receive the elements of message data, which include the session identifier, the agent identifier, the digitally signed, secure data package, and one or more elements of digital content, from computing system 130 across network 120 within the initiated, and ongoing, secure, programmatic chat session (e.g., in step 310 of FIG. 3). In some instances, client device 102 may perform any of the exemplary processes described herein to validate the digital signature applied to the elements of the secure data package and maintained within the digitally signed, secure data package (e.g., in step 312 of FIG. 4). Based on the validation of the applied digital signature, client device 102 may obtain the elements of digital content from the received elements of message data and may generate one or more elements of textual content associated with the wallet-compatible product (e.g., in step 314 of FIG. 3). As described herein, the elements of textual content may confirm the issuance of the wallet-based product and may indicating that the wallet-based instrument is ready for addition into the digital wallet of user 101, and in some instances, client device 102 may perform any of the exemplary processes described herein to present each, or a selected subset of, the elements of digital content and textual content within corresponding portions of the digital interface, such as digital interface 220 associated with executed mobile application 108 (e.g., also in step 314 of FIG. 3).

Based on the presentation of the digital content and the textual content within the digital interface, client device 102 may receive, via input unit 114, input from user 101 that authorizes expressly the addition of the wallet-compatible product to the digital wallet of user 101 (e.g., in step 316 of FIG. 3). Based on the received input, client device 102 may perform any of the exemplary processes described herein to obtain the secure data package within the digitally signed data package, which includes the digital token associated with the account number of the wallet-compatible product, the public key associated with the digital token, and in some instances, an additional public key associated with the card verification code, within a secure partition of a tangible, non-transitory memory of client device 102, such as a secure element of an iPhone™ device (e.g., in step 318 of FIG. 3). Upon storage of the secure data package within the secure partition 284 of the tangible, non-transitory memory, the wallet-compatible product is added to the digital wallet and is available for use in contactless or digital transactions via executed wallet application 110.

In some instances, client device 102 may also perform operations that transmit, across network 120 to computing system 130, a further element of message data indicating a termination of the initiated, and ongoing, secure, programmatic chat session (e.g., in step 320 of FIG. 3). Exemplary process 300 is then complete in step 322.

Referring to FIG. 4, computing system 130 may receive a request to initiate a secure, programmatic chat session with an agent of an organization from client device 102 across network 120 (e.g., in step 402 of FIG. 4). As described herein, client device 102 may generate the request in response to elements of input provisioned to client device 102 by a corresponding user, such as user 101, and as described herein, the request by be generated by an application program executed at client device 102, such as mobile application 108. Further, and as described herein, the request may include, one or more of the authentication credentials of user 101, an identifier of executed mobile application 108 (e.g., an application cryptogram or token of specified format a, etc.), an identifier of client device 102 (e.g., an IP or MAC address, etc.), and in some instances, elements of data that confirm the successful authentication of an identity of user 101, such as, but not limited to, a digital signature applied to the request.

In some instances, computing system 130 may perform any of the exemplary processes described herein to validate the digital signature applied to the received request, and based on the validation of the applied digital signature, computing system 130 may perform any of the exemplary processes described herein to generate a unique session identifier for the secure, programmatic chat session associated with the received request (e.g., in step 404 of FIG. 4). Computing system 130 may also perform any of the exemplary processes described herein to allocate the secure, programmatic chat session associated with the received request to an available agent of the organization, such as, but not limited to, agent 151 associated with agent device 152 (e.g., in step 406 of FIG. 4). The disclosed embodiments are, however, not limited to processes that allocate the secure, programmatic chat session associated with the received request to an agent operating a corresponding agent device or computing system, and in other examples, the agent may correspond to an interactive chatbot of the organization, which may be generated programmatically by the one or more processors of computing system 130, e.g., by executed chatbot engine 144.

Referring back to FIG. 4, computing system 130 may perform any of the exemplary processes described herein to initiate the secure, programmatic chat session between client device 102, computing system 130, and agent device 152 (and additionally, or alternatively, the interactive chatbot generated programmatically by executed chatbot engine 144), and to generate and store elements of session data that identify and characterize the secure, programmatic chat session, the allocated agent and agent device, and the requesting user and client device (e.g., in step 408 of FIG. 4). In some instances, computing system 130 may generate elements of initiation data associated with the initiated, secure, programmatic chat session, and transmit the elements of initiation data across network 120 to client device 102 and across network 140 to agent device 152 (e.g., in step 410 of FIG. 4). As described herein, the elements of initiation data may include the unique session identifier of the chat session, temporal data associated with the initiation of the chat session, unique identifiers of the requesting user and the agent, and in some instances, elements of textual content indicating the initiation of the chat session.

Within the initiated, and ongoing, secure, programmatic chat session, computing system 130 may receive elements of messaging data and in some instances, a digital signature applied to the elements of message data, from client device 102 across network 120 (e.g., in step 412 of FIG. 4). As described herein the received elements of message data may indicate an intention of user 101 to apply for a wallet-compatible product available for provisioning by the organization, and the received elements of message data may include input data (e.g., textual content) specifying the intention of user 101 to apply for the wallet-compatible product, the session identifier of the secure, programmatic chat session, and the identifier of user 101. Examples of the wallet-compatible product may include, but are not limited to, a payment instrument, a loyalty or rewards account, a government-issued identifier (such as a driver's license, etc.), a medical credential (e.g., a vaccination record), a transit passe (e.g., a Presto™ card, etc.), and a stored-value card associated with a corresponding retailer (e.g., a Starbucks™ gift card, etc.). In some instances, computing system 130 may perform any of the exemplary processes described herein to validate the digital signature applied to the received elements of messaging data, and based on the validation of the applied digital signature, computing system 130 may perform operations, described herein, that transmit the elements of message data across network 140 to agent device 152 within the initiated, and ongoing, secure, programmatic chat session (e.g., also in step 412 of FIG. 4).

As described herein, based on the intention of user 101 to apply for the wallet-compatible product, client device 102 and agent device 152 may perform any of the exemplary processes described herein to exchange additional elements of message data via computing system 130 within the initiated, and ongoing, secure, programmatic chat session established between client device 102, computing system 130, and agent device 152. In some instances, computing system 130 may perform any of the exemplary processes described herein to receive each of the additional elements of message data from client device 102 across network 120, or from agent device 152 across network 140, to verify an authenticity and an integrity of each of the additional elements of message data, and to transmit each of the additional elements of message data to a corresponding recipient (e.g., in step 414 of FIG. 4).

The additional elements of message data exchanged between client device 102 and agent device 152 within the initiated, and ongoing, secure, programmatic chat session may enable agent 151 to confirm the intention of user 101 to obtain the wallet-compatible product, and may enable executed agent device 152 to further verify the identity of user 101 and to obtain additional information that facilitates, and supports, an application for the wallet-compatible product on behalf of user 101. For example, the additional information may include, but is not limited to, a full legal name of user 101, a mailing address of user 101, a governmental identifier assigned to user 101 (e.g., a driver's license number, a social security number, etc.), a date of birth, and financial data associated with user 101, such as, but not limited to, a current employer and current income of user 101. The disclosed embodiments are, however, not limited to these additional and further elements of message data, and in other examples, agent device 152 and user 101 may exchange any additional, or alternate, elements of message data (e.g., within the secure, programmatic chat session established between executed mobile application 108, executed chat server 142, and executed agent desktop application 158) that facilitate the application for the wallet-compatible product on behalf of user 101.

By way of example, based on the additional information and on elements of profile data that identify and characterize user 101, agent device 152 may perform any of the exemplary processes described herein to generate one or more elements of application data that identify and characterize the user 101 and the wallet-compatible product available for provisioning by approval system 170, The elements of application data may, for example, correspond to an application for the wallet-compatible product on behalf of user 101, and in some instances, agent device 152 may transmit the elements of application data across network 140 to approval system 170. As described herein, approval system 170 may perform any of the exemplary processes described herein to apply one or more adjudication criteria to the elements of application data and based on a successful adjudication, to approve the wallet-compatible product for user 101 and to provision, to agent device 152, a digitally signed, secure data packet that facilitates an addition of the approved, wallet-compatible product to the digital wallet of user 101, which may be maintained by executed wallet application 110 within a secure memory partition of memory 106 of client device 102 (e.g., a secure element of the customer's iPhone™ device).

The digitally signed, secure data package may include a secure data package associated with the approved, wallet-compatible product, which stores a digital token associated with the account number of the wallet-compatible product, a corresponding public key associated with the digital token, and in some instances, an additional public key associated with a card verification code of the approved, wallet-compatible product. Further, the digitally signed, secure data package may also include a digital signature, which may be applied to the secure data package by approval system 170 using any of the exemplary processes described herein. In some instances, agent device 152 may transmit elements of message data that include the session identifier, an agent identifier of agent 151 (e.g., an alphanumeric identifier, etc.), the digitally signed, secure data package, and one or more elements of digital content associated with the wallet-compatible product across network 140 to computing system 130 within the initiated, and ongoing, secure, programmatic chat session Referring back to FIG. 4, computing system 130 may receive the elements of message data, which include the session identifier, the agent identifier, the digitally signed, secure data package, and the one or more elements of digital content from agent device 152 across network 140 (e.g., in step 416 of FIG. 4). Computing system 130 may perform any of the exemplary processes described herein to validate the digital signature applied to the elements of the secure data package and maintained within the digitally signed, secure data package (e.g., in step 418 of FIG. 4). Based on the validation of the applied digital signature, computing system 130 also perform operations that transmit the received elements of message data (e.g., including the session identifier, the agent identifier, the digitally signed, secure data package, and the one or more elements of digital content) across network 120 to client device 102 (e.g., in step 420 of FIG. 4). In some examples, through the transmission of the elements of message data that include the digitally signed, secure data package across network 120 to client device 102 during the initiated, and ongoing chat session, computing system 130 may facilitate a provisioning of wallet-compatible product to a digital wallet maintained at client device 102 by executed wallet application 110 in real-time and contemporaneously with the issuance of the wallet-compatible product to user 101 and without requiring a possession of the physical instrument by user 101.

In some instances, upon provisioning of the wallet-compatible product into the digital wallet maintained at client device 102, computing system 130 may receive a further element of message data across network 120 from client device 102, which may indicate a termination of the secure, programmatic chat session by client device 102, and computing system 130 may perform any of the exemplary processes described herein to route the further element of message data to agent device 152 across network 120 (e.g., in step 422 of FIG. 4). Exemplary process 400 is then complete in step 424.

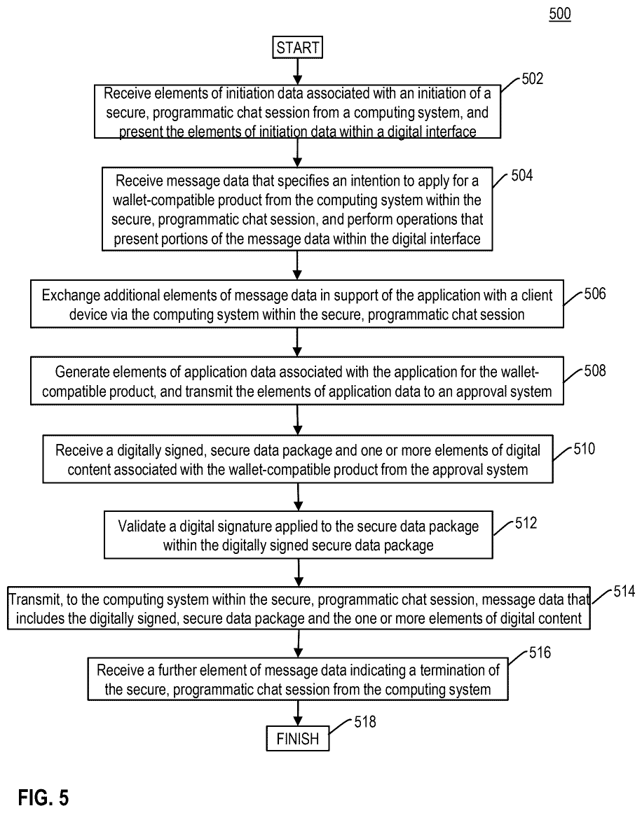

Referring to FIG. 5, agent device 152 may receive, from computing system 130 across network 140, elements of initiation data that characterize a secure, programmatic chat session initiated between client device 102, computing system 130, and agent device 152 (e.g., in step 502 of FIG. 5). As described herein, computing system 130 may initiate the chat session based on a request received from client device 102 across network 120, and computing system 130 may perform any of the exemplary processes described herein to allocate the secure, programmatic chat session to agent 151 associated with agent device 152. In some instances, the elements of initiation data may include the unique session identifier of the secure, programmatic chat session, temporal data associated with the initiation of the secure, programmatic chat session, unique identifiers of the requesting user and the agent, and additionally, or alternatively, elements of textual content indicating the initiation of the chat session. Agent device 152 may perform any of the exemplary processes described herein to present portions of the received elements of initiation data within corresponding interface elements of a digital interface, such as, but not limited to, digital interface 228 associated with executed agent desktop application 158 (e.g., also in step 502 of FIG. 5).

Within the initiated, and ongoing, secure, programmatic chat session, agent device 152 may receive elements of messaging data and in some instances, a digital signature applied to the elements of message data, from computing system 130 across network 140 (e.g., in step 504 of FIG. 5). As described herein the received elements of message data may indicate an intention of user 101 to apply for a wallet-compatible product available for provisioning by the organization, and the received elements of message data may include input data (e.g., textual content) specifying the intention of user 101 to apply for the wallet-compatible product, the session identifier of the secure, programmatic chat session, and the identifier of user 101. Examples of the wallet-compatible product may include, but are not limited to, a payment instrument, a loyalty or rewards account, a government-issued identifier (such as a driver's license, etc.), a medical credential (e.g., a vaccination record), a transit passe (e.g., a Presto™ card, etc.), and a stored-value card associated with a corresponding retailer (e.g., a Starbucks™ gift card, etc.).

In some instances, agent device 152 may perform any of the exemplary processes described herein to validate the digital signature applied to the received elements of messaging data, and based on the validation of the applied digital signature, computing system 130 may perform operations, described herein, that generate one or more interface elements based on the elements of messaging data and that present the one or more interface elements within a corresponding portion of the digital interface. such as, but not limited to, digital interface 228 associated with executed agent desktop application 158 (e.g., also in step 504 of FIG. 5). In some instances, the one or more generated interface elements, when rendered for presentation within digital interface 228 (e.g., via display unit 160), indicate the intention of user 101 to obtain the wallet-compatible product during initiated, and ongoing, secure, programmatic chat session.

In some instances, based on the intention of user 101 to apply for the wallet-compatible product, agent device 152 may perform any of the exemplary processes described herein to generate and exchange additional elements of message data with client device 102 via computing system 130 within the initiated, and ongoing, secure, programmatic chat session established between client device 102, computing system 130, and agent device 152 (e.g., in step 506 of FIG. 5). As descried herein, the additional elements of message data exchanged between agent device 152 and client device 102 within the initiated, and ongoing, secure, programmatic chat session may enable agent 151 to confirm the intention of user 101 to obtain the wallet-compatible product, and may enable executed agent desktop application 158 to further verify the identity of user 101 and to obtain additional information that facilitates, and supports, an application for the wallet-compatible product on behalf of user 101.

For example, the additional information may include, but is not limited to, a full legal name of user 101, a mailing address of user 101, a governmental identifier assigned to user 101 (e.g., a driver's license number, a social security number, etc.), a date of birth, and financial data associated with user 101, such as, but not limited to, a current employer and current income of user 101. The disclosed embodiments are, however, not limited to these additional elements of message data, and in other examples, agent 151 and user 101 may exchange any additional, or alternate, elements of message data (e.g., within the secure, programmatic chat session established between client device 102, computing system 130, and agent device 152) that facilitate the application for the wallet-compatible product on behalf of user 101.

Based on the additional information obtained from the additional elements of message data, and based on elements of profile data that identify and characterize user 101, agent device 152 may perform any of the exemplary processes described herein to generate one or more elements of application data that identify and characterize the user 101 and the wallet-compatible product available for provisioning by approval system 170 (e.g., in step 508 of FIG. 5). The elements of application data may, for example, correspond to an application for the wallet-compatible product on behalf of user 101, and in some instances, agent device 152 may transmit the elements of application data across network 140 to approval system 170 (e.g., also in step 508 of FIG. 5).

As described herein, approval system 170 may perform any of the exemplary processes described herein to apply one or more adjudication criteria to the elements of application data and based on a successful adjudication, to approve the wallet-compatible product for user 101 and to provision, to agent device 152, a digitally signed, secure data packet that facilitates an addition of the approved, wallet-compatible product to the digital wallet of user 101, which may be maintained by executed wallet application 110 within a secure memory partition of memory 106 of client device 102 (e.g., a secure element of the customer's iPhone™ device). The digitally signed, secure data package may include a secure data package associated with the approved, wallet-compatible product, which stores a digital token associated with the account number of the wallet-compatible product, a corresponding public key associated with the digital token, and in some instances, an additional public key associated with a card verification code of the approved, wallet-compatible product. Further, the digitally signed, secure data package may also include a digital signature, which may be applied to the secure data package by approval system 170 using any of the exemplary processes described herein.

Referring back to FIG. 5, agent device 152 may receive the digitally signed data packet associated with the approved, wallet-compatible product and one or more elements of digital content associated with the wallet-compatible product from approval system 170 across network 140 (e.g., in step 510 of FIG. 5). In some instances, the one or more elements of digital content may correspond to a digital image of a physical instrument (e.g., a card face) associated with the approved, wallet-compatible product, and agent device 152 may perform any of the exemplary processes described herein to validate the digital signature applied to the elements of the secure data package and maintained within the digitally signed, secure data package (e.g., in step 512 of FIG. 5).

Based on the validation of the applied digital signature, agent device 152 may generate elements of message data that include the session identifier, an agent identifier of agent 151 (e.g., an alphanumeric identifier, etc.), the digitally signed, secure data package, and the elements of digital content, and agent device 152 may transmit the elements of message data across network 140 to computing system 130 within the initiated, and ongoing, secure, programmatic chat session (e.g., in step 514 of FIG. 5). In some examples, through the transmission of the elements of message data that include the digitally signed, secure data package across network 140 to computing system 130, agent device 152 may inject the digitally signed, secure data package into the secure, programmatic chat session established between client device 102, computing system 130, and agent device 152, and may facilitate a provisioning of wallet-compatible product to a digital wallet maintained at client device 102 by executed wallet application 110 in real-time and contemporaneously with the issuance of the wallet-compatible product to user 101 and without requiring a possession of the physical instrument by user 101.

In some instances, upon provisioning of the wallet-compatible product into the digital wallet maintained at client device 102, agent device 152 may receive a further element of message data across network 140 from computing system 130, which may indicate a termination of the secure, programmatic chat session by client device 102 (e.g., in step 516 of FIG. 5). Exemplary process 500 is then complete in step 518.

### C. Exemplary Computing Architectures

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Exemplary embodiments of the subject matter described in this specification, including, but not limited to, mobile application 108, wallet application 110, chat server 140, chatbot engine 138, agent desktop application 158, adjudication engine 178, provisioning engine 180, application programming interfaces (APIs) 204, 217, and 224, authentication module 206, session initiation module 208, and session management module 242, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random-access memory or both. The essential elements of a computer are a central processing unit for performing or executing instructions and one or more memory devices for storing instructions and data. Generally, a computer will also include, or be operatively coupled to receive, data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to exemplary embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

1. A device, comprising:
a memory storing instructions;
a communications interface; and
at least one processor coupled to the memory and the communications interface, the at least one processor being configured to execute the instructions to:
receive message data via the communications interface, the message data being received during a chat session established with between the device and at least a computing system, and the message data comprising a data package associated with an approved product and a corresponding digital signature;
present digital content characterizing the approved product within a digital interface associated with the established chat session, and obtain elements of input data associated with the presented digital content; and
based on the elements of input data, perform operations that store at least a portion of the data package within a secure portion of the memory, the secure portion of the memory being associated with a first application program executed by the at least one processor, and the stored portion of the data package provisioning the approved product into a digital wallet associated with the executed first application program.

2. The device of claim 1, wherein the at least one processor is further configured to execute the instructions to receive the message data from the computing system via the communications interface during the established chat session, the established chat session involving an autonomous agent.

3. The device of claim 1, wherein the at least one processor is further configured to execute the instructions to:
validate the digital signature based on the elements of input data; and
based on the validation of the digital signature, perform the operations that store at least the portion of the data package within the secure portion of the memory.

4. The device of claim 1, wherein:
the message data comprises the data package associated with the approved product, the corresponding digital signature, and the digital content characterizing the approved product; and
the data package, the corresponding digital signature, and the digital content being generated by an additional computing system associated with the approved product.

5. The device of claim 1, wherein the at least one processor is further configured to execute the instructions to:
transmit a request to establish the chat session to the computing system via the communications interface, the computing system being configured to establish the chat session between the device and at least the computing system based on the request and generate elements of session data that characterize the established chat session;
receive, via the communications interface, elements of initiation data from the computing system during the established chat session, the elements of initiation data characterizing the established chat session and comprising at least a subset of the elements of session data; and
present at least a subset of the elements of initiation data within corresponding portions of the digital interface.

6. The device of claim 1, wherein:
the chat session is established between the device, the computing system, and an additional device;
the device and the computing system are interconnected across a first communications network; and
the computing system and the additional device are interconnected across a second communications network, the second communications network being inaccessible to the device via the first communications network.

7. The device of claim 6, wherein:
the additional device is configured to generate the message data, and to transmit the message data to the computing system across the second communications network, during the established chat session; and
the at least one processor is further configured to receive, across the first communications network via the communications interface, the message data from the computing system during the established chat session.

8. The device of claim 6, wherein:
the at least one processor is further configured to transmit, across the first communications network via the communications interface, additional message data to the computing system during the established chat session, the additional message data comprising a request to obtain the product; and
the computing system is configured to transmit the additional message data to the additional device across the second communications network during the established chat session;
the additional device is configured to obtain the data package and the corresponding digital signature from an additional computing system and to transmit the data package and the corresponding digital signature across the second communications network during the established chat session, the additional computing system being configured to approve to product based on corresponding elements of application data.

9. The device of claim 1, wherein the at least one processor is further configured to execute the instructions to:
determine that the input data is associated with an authorization to provision the approved product into the digital wallet associated with the executed application program; and
based on the determination that the input data is associated with the authorization, perform the operations that store at least the portion of the data package within the secure portion of the memory.

10. The device of claim 1, wherein the approved product is associated with a product credential, and the data package comprises a digital token representative of the product credential and a public cryptographic key associated with the digital token.

11. The device of claim 1, wherein:
the device further comprises an input unit and a display unit, each of the input unit and the display unit being coupled to the at least one processor; and
the at least one processor is further configured to executed the instructions to:
present the digital content characterizing the approved product within the digital interface via the display unit; and
receive the input data associated with the presented digital content via the input unit.

12. A computer-implemented method, comprising:
receiving message data using at least one processor, the message data being received during a chat session established between a device and a computing system, and the message data comprising a data package associated with an approved product and a corresponding digital signature;
presenting, using the at least one processor, digital content characterizing the approved product within a digital interface associated with the established chat session, and obtaining, using the at least one processor, elements of input data associated with the presented digital content; and
based on the elements of input data, performing operations, using the at least one processor, that store at least a portion of the data package within a secure portion of a memory, the secure portion of the memory being associated with an application program executed by the at least one processor, and the stored portion of the data package provisioning the approved product into a digital wallet associated with the executed application program.

13. A device, comprising:
a memory storing instructions;
a communications interface; and
at least one processor coupled to the memory and the communications interface, the at least one processor being configured to execute the instructions to:
receive first message data via the communications interface, the first message data being received during a chat session established between the device and a computing system;
transmit, via the communications interface, elements of application data that include at least a portion of the first message data to an additional computing system, the additional computing system performing operations that approve a product based on the elements of application data;
receive, via the communications interface, a data package associated with the approved product and a corresponding digital signature from the additional computing system; and
transmit, via the communications interface, second message data to the computing system during the established chat session, the second message data comprising the data package and the digital signature, and the computing system being configured to transmit the second message data to an additional device during the established chat session.

14. The device of claim 13, wherein the at least one processor is further configured to execute the instructions to:
validate the corresponding digital signature; and
based on the validation of the digital signature, generate the second message data and transmit, via the communications interface, the second message data to the additional device during the established chat session.

15. The device of claim 13, wherein:
the chat session is established between the device, the computing system, and the additional device;
the device and the computing system are interconnected across a first communications network; and
the computing system and the additional device are interconnected across a second communications network, the first communications network being inaccessible to the additional device via the second communications network.

16. The device of claim 15, wherein:
the first message data is generated by the additional device during the established chat session; and
the at least one processor is further configured to execute the instructions to receive, via the communications interface, the first message from the computing system across the first communications network.

17. The device of claim 13, wherein the additional device is configured to:
receive the second message data from the device during the established chat session;
present digital content characterizing the approved product within a digital interface associated with the established chat session, and obtain elements of input data associated with the presented digital content;
based on the elements of input data, perform operations that store at least a portion of the data package within a secure portion of the memory, the secure portion of an additional memory being associated with an application program executed by the additional device, and the stored portion of the data package provisioning the approved product into a digital wallet associated with the executed application program.

18. The device of claim 13, wherein the approved product is associated with a product credential, and the data package comprises a digital token representative of the product credential and a public cryptographic key associated with the digital token.

19. The device of claim 14, wherein the at least one processor is further configured to execute the instructions to generate the elements of application data based on the at least a portion of first message data and on at least one element of profile data associated with the additional device.

20. The device of claim 14, wherein:
the at least one processor is further configured to execute the instructions to receive, via the communications interface, the data package associated with the approved product, the corresponding digital signature, and digital content associated with the approved product from the additional computing system;
the second message data comprises the data package, and the digital signature, and the digital content; and
the additional device is configured to present at least a portion of the digital content within a digital interface.
